(19) United States
(12) Patent Application Publication
(10) Pub. No.: US 2018/0113583 A1
(43) Pub. Date: Apr. 26, 2018

(54) DEVICE AND METHOD FOR PROVIDING AT LEAST ONE FUNCTIONALITY TO A USER WITH RESPECT TO AT LEAST ONE OF A PLURALITY OF WEBPAGES

(71) Applicant: SAMSUNG ELECTRONICS CO., LTD., Suwon-si (KR)

(72) Inventors: Arihant JAIN, Sahibabad (IN); Himanshu GUPTA, Kulpahar (IN)

(73) Assignee: SAMSUNG ELECTRONICS CO., LTD., Suwon-si (KR)

(21) Appl. No.: 15/789,365

(22) Filed: Oct. 20, 2017

(30) Foreign Application Priority Data
Oct. 20, 2016 (IN) 201611035958

(51) Int. Cl. G06F 3/0483; G06F 17/22; G06F 3/0482

(52) U.S. Cl. CPC G06F 3/0483; G06F 17/2705; G06F 3/0482; G06F 17/2247

(57) ABSTRACT

Devices and methods for providing at least one functionality to the user with respect to at least one of a plurality of webpages are provided. The method may include: extracting at least one key point from each of a plurality of webpages corresponding to each of a plurality of tabs that are open on a web browser; comparing the at least one key point corresponding to the each of the plurality of web-pages with each other; and providing, based on a result of the comparing the at least one key point, at least one functionality to a user with respect to at least one of the plurality of webpages.

### CROSS-REFERENCE TO RELATED APPLICATION(S)

This application claims priority from Indian Patent Application No. 201611035958, filed on Oct. 20, 2016 in the Indian Patent Office, the entire disclosure of which is hereby incorporated by reference.

### FIELD

Example embodiments of present disclosure relate to a device and method for providing at least one functionality to a user with respect to at least one of a plurality of webpages.

### BACKGROUND

Many news websites, product review websites, e-commerce websites, blogs etc. provide information related to events, products, etc. Most of the times, the problem a user faces in browsing multiple websites presenting information on the same topic is that 70-80% of information presented on each duplicative across different webpages. This results in forcing the user to go through the same information multiple times just to find what extra information may be present on a given website. If the content present on the webpages is mostly text-based, then it is more inconvenient for the user to identify what is new information presented in this content. Also, if the user finds the answer to his query on the first search result page, he has to manually close the rest of the search result tabs. Related art methods have not been able to address this problem in an effective manner.

For example, a page comparison tool may compare the text across two different pages. The results may display information including the Page Title, Meta Tag info, and common phrases occurring on the pages in a side by side analysis, as illustrated in FIG. 1. As shown, the user provides Uniform Resource Locators (URLs) of the webpages to be compared in the fields 101 and 102. Once the information is entered, the webpages are compared and comparison result 103 is provided. As shown, the comparison results show information such as Page Title, Page Description, Keywords and Content Similarity percentage. In another example, a page comparison tool may find copies of the user's webpage online as well as providing a solution for detecting or preventing an unauthorized reproduction of content. The same has been illustrated in FIG. 2. As shown, the user provides URLs of the webpages to be compared in the fields 201 and 202 or paste the text in the fields 204 and 205. On inputting the information, the webpages are compared and comparison result 203 is provided. As shown, the comparison result shows a total number of words, a number of matching words and a percentage of matched content. In yet another example, a page comparison tool may include a simple page compare application. It may help web developers and designers to see the difference between webpages based on their underlying Hypertext Markup Language (HTML) code (text). The tool may not necessarily examine the original page source, but take into consideration browser-generated Document Object Model (DOM)-compliant view source. For example, the comparison tool may omit Doctype declarations and HTML tags. All of the page comparison tools discussed above, however, suffer from a deficiency of being able to comparing only two websites (i.e. a first website and a second website) and does not attempt to identify what new content might be present on the second website when a user switches from the first website to the second website.

In yet another example may involve a computerized method for monitoring the content of the documents. A set of documents may be stored in memories of server computers. The first and second abstracts are compared to identify documents that have changed between the time the set of documents were indexed and the time the result set is generated. A webpage may be updated at certain time intervals by comparing content of a previous version of a webpage and the latest version of the webpage so that if any content is updated on that particular webpage, the change will be detected. However, such method fails to provide a contextual comparison of two different webpages based upon information requested by user.

In still another example, a synchronized comparison and present system may present a similar webpage when a page in a website is presented, in a different site based on a search keyword automatically obtained in the page simultaneously and automatically, and also control a display mode of the similar page to be synchronous with a display mode of the original webpage. This method, however, does not identify what is contextually different between the webpages and what new information might be present on a webpage.

In still yet another example, a system may include a module for receiving an identifier of a base site that becomes the basis of a displayed presentation and receives an identifier of a compared website displayed in a language different from that of the base site, a module for specifying a base page from the base site, a module for consolidating words of different languages into a single language, a module for producing information for comparing the base page, a module for specifying a related page similar to the base page from among each compared page based on the word information of the base page and the word information of each compared page, and a module for presenting the related page together with the base page on the same display screen. This system aims to provide related webpages based upon content of current webpage. However, it does not provide any mechanism to highlight or identify what new content is present on a related webpage.

In light of the foregoing, with conventional methods and devices, it is difficult to identify new content on a website when a user switches from a previous website to another website related to a common topic. Also, the user activity pattern is not considered when switching between multiple websites related to the same topic. Further, content that has already been browsed and/or un-browsed on a webpage is not identified.

Thus, there is an unmet need for a device and method that overcomes the disadvantages of the conventional devices in a simple and efficient manner.

### SUMMARY

One or more example embodiments provide a device and a method for providing functionalities based on webpage similarity analysis.

According to an aspect of an example embodiment, a method for providing at least one functionality using an electronic device, the method including: receiving a first user input for selecting a plurality of first webpages through a web browser; identifying, based on a predetermined criterion, a plurality of second webpages from the plurality of first webpages, the plurality of second webpages being related to each other; extracting key points corresponding to each of the plurality of second webpages; comparing the key points corresponding to the each of the plurality of second webpages; providing, based on a result of the comparing the key points, at least one functionality to a user with respect to the plurality of second webpages. According to an aspect of an example embodiment, a device may include a display, an input device, and a processor electrically connected to the display and the input device. The processor may be configured to: receive, through the input device, a first user input for selecting a plurality of first webpages through a web browser; identify, based on a predetermined criterion, a plurality of second webpages from the plurality of first webpages. The plurality of second webpages being related to each other; extract key points corresponding to each of the plurality of second webpages; compare the key points corresponding to the each of the plurality of second webpages with each other; and provide, based on a result of the comparing the key points, at least one functionality to a user with respect to the plurality of second webpages.

### BRIEF DESCRIPTION OF DRAWINGS:

To further clarify advantages and aspects of the disclosure, a more particular description of the disclosure will be rendered with reference to specific embodiments thereof, which is illustrated in the appended drawings. It is appreciated that these drawings depict only example embodiments of the disclosure and are therefore not to be considered limiting of its scope. The disclosure will be described and explained with additional specificity and detail with the accompanying drawings in accordance with various embodiments of the disclosure, wherein:

FIGS. 1 and 2 illustrate related art;

FIG. 3 illustrates a method for providing at least one functionality to the user with respect to the plurality of the webpages, in accordance with an example embodiment;

FIG. 4 illustrates a method for providing at least one functionality to the user with respect to the plurality of the webpages, in accordance with an example embodiment;

FIGS. 5A and 5B illustrate the extraction of key points from webpages, in accordance with an example embodiment;

FIGS. 6A to 6C illustrate functionalities provided to the user on closing one or more webpages, in accordance with an example embodiment;

FIGS. 7A to 7C illustrate functionalities provided to the user on closing one or more webpages, in accordance with an example embodiment;

FIGS. 8A to 8C illustrate functionalities provided to the user on closing one or more webpages, in accordance with an example embodiment;

FIGS. 9A and 9B illustrate functionalities provided to the user on closing one or more webpages, in accordance with an example embodiment;

FIGS. 10A and 10B illustrate functionalities provided to the user on closing one or more webpages, in accordance with an example embodiment;

FIGS. 11A to 11D illustrate functionalities provided to the user wherein the user pattern is one of: switching between webpages, opening one or more webpages, navigating within the webpages and switching between web browser windows, in accordance with an example embodiment;

FIGS. 12A to 12D illustrate functionalities provided to the user wherein the user pattern is one of: switching between webpages, opening one or more webpages, navigating within the webpages and switching between web browser windows, in accordance with an example embodiment;

FIGS. 13A to 13D illustrate functionalities provided to the user wherein the user pattern is one of: switching between webpages, opening one or more webpages, navigating within the webpages and switching between web browser windows, in accordance with an example embodiment;

FIGS. 14A to 14D illustrate functionalities provided to the user wherein the user pattern is one of: switching between webpages, opening one or more webpages, navigating within the webpages and switching between web browser windows, in accordance with an example embodiment;

FIGS. 15A to 15C illustrate functionalities provided to the user wherein the user pattern is one of: switching between webpages, opening one or more webpages, navigating within the webpages and switching between web browser windows, in accordance with an example embodiment;

FIGS. 16A to 16C illustrate functionalities provided to the user, in accordance with an example embodiment;

FIGS. 17A to 17D illustrate functionalities provided to the user, in accordance with an example embodiment;

FIGS. 18A to 18D illustrate functionalities provided to the user, in accordance with an example embodiment;

FIGS. 19A to 19C illustrate functionalities provided to the user, in accordance with an example embodiment;

FIG. 20 illustrates constructional details of a device, in accordance with an example embodiment;

FIG. 21 illustrates constructional details of a device, in accordance with an example embodiment; and

FIG. 22 illustrates a typical hardware configuration of the device in the form of a computer system, in accordance with an example embodiment.

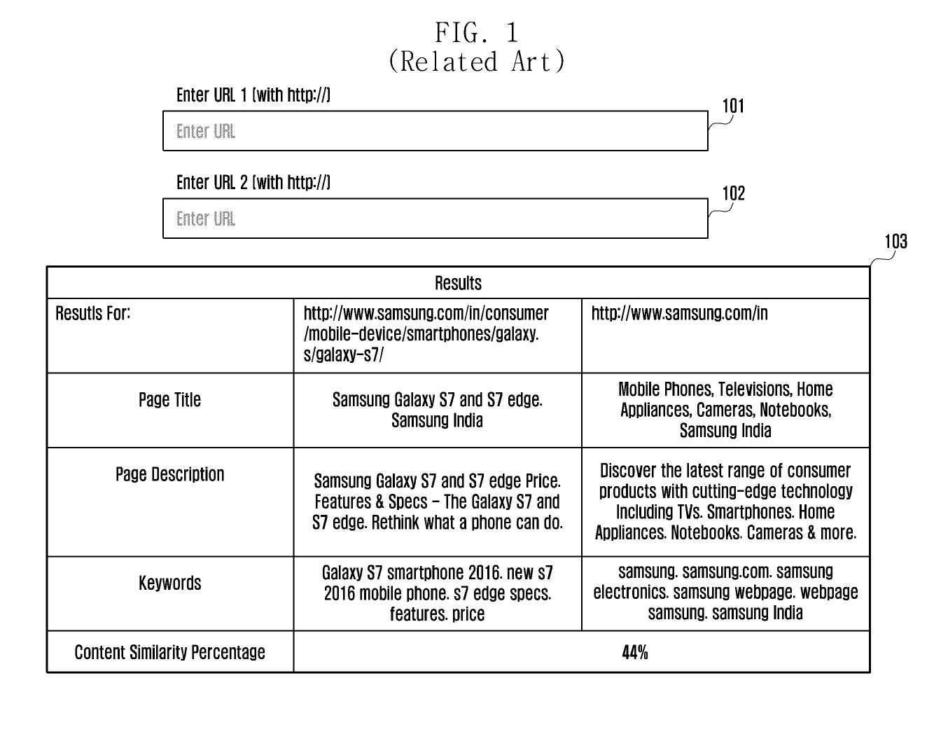

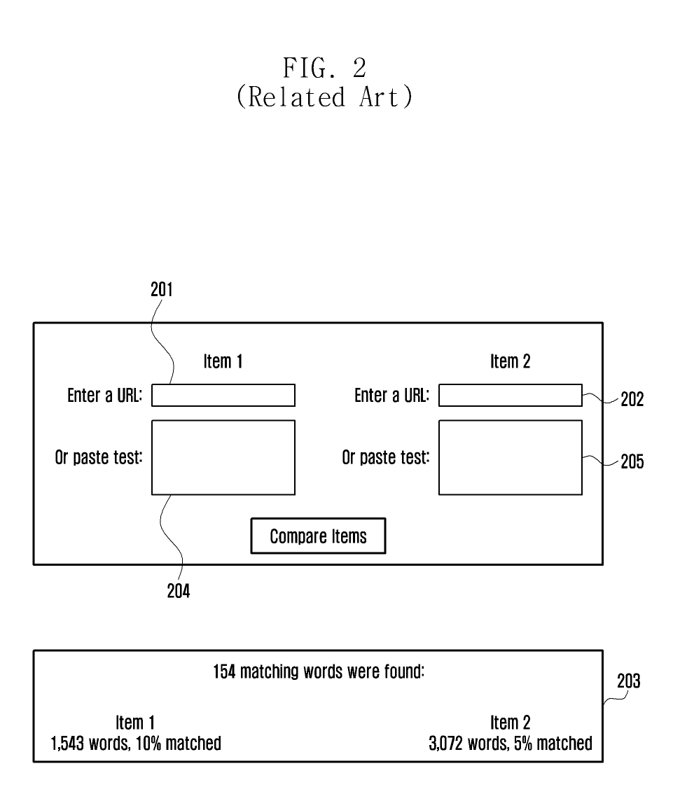

### DETAILED DESCRIPTION

It should be understood at the outset that although illustrative implementations of the example embodiments of the present disclosure are illustrated below, the present disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents. The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.” The terminology and structure employed herein is for describing, teaching and illuminating some embodiments and their specific features and elements and does not limit, restrict or reduce the spirit and scope of the claims or their equivalents. More specifically, any terms used herein such as but not limited to “includes,” “comprises,” “has,” “consists,” and grammatical variants thereof do not specify an absolute limitation or restriction and certainly do not exclude the possible addition of one or more features or elements, unless otherwise stated, and furthermore must not be taken to exclude the possible removal of one or more of the listed features and elements, unless otherwise stated with the limiting language such as “must comprise” or “needs to include,” etc.

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required. Unless otherwise defined, all terms, and especially any technical and/or scientific terms, used herein may be taken to have the same meaning as commonly understood by one having an ordinary skill in the art. Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness. Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment. Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below.

Those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the disclosure. Furthermore, the one or more elements may have been represented in the drawings by conventional symbols, and the drawings may show only those specific details that are pertinent to understanding the embodiments of the disclosure so as not to obscure the drawings with details that will be readily apparent to those of ordinary skill in the art having benefit of the description herein.

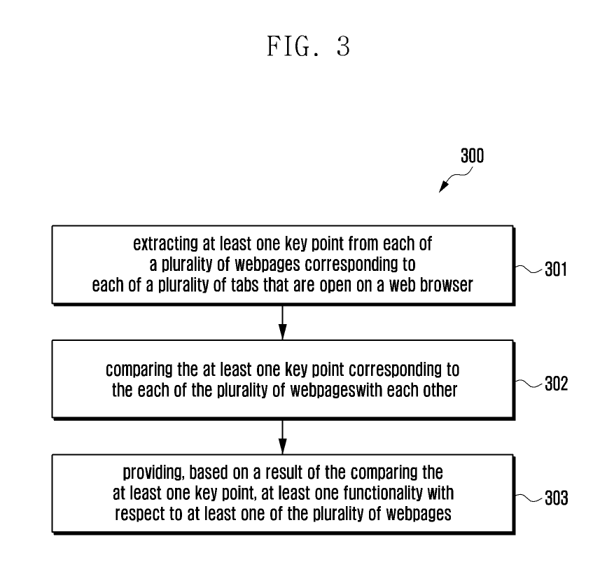

FIG. 3 illustrates a method 300 for providing at least one functionality to the user with respect to at least one of the plurality of the webpages, in accordance with an exemplary embodiment.

At operation 301, at least one key point (e.g., keywords) corresponding to each of the webpages are extracted from each of the plurality of webpages. Content of each webpage may be analyzed to extract the key points corresponding to each of the webpages. A user may select webpages through a web browser to open the webpages in multiple tabs of the web browser. For example, each of the plurality of webpages may correspond to each of a plurality of tabs that are open on a web browser.

At operation 302, the at least one key point corresponding to each of the plurality of webpages are compared to each other.

At operation 303, based on a result of comparing the at least one key point at operation 302, at least one functionality is provided to the user with respect to at least one of the plurality of webpages.

The method 300 may further include, based on a predetermined criterion, identifying whether the plurality of webpages are related to each other. Related webpages may share common topics, keywords, formats, content, etc. The relatedness of websites may be determined based on a number of shared topics, keywords, etc. and threshold value.

The method 300 may further include dynamically updating at least one functionality based on one or more of: (a) interaction with currently opened webpage, and (b) detection of a new related webpage.

The predetermined criterion for identifying a plurality of webpages, as depicted at operation 301, includes presence of at least one matching or similar text in one or more of: (a) URL of the webpages, (b) title of the webpages, the title extracted from a DOM tree structure created for each webpage, (c) heading of the webpages, the heading extracted from the DOM tree structure created for each webpage, and (d) metadata within the webpages.

The presence of at least one matching or similar text in the URL of the webpages can be explained as follows. In an example embodiment, if multiple webpages are open through links which are present on the parent page, there is a high chance some of the opened webpages (i.e. child pages) are related. Also, in such cases, the URLs of the parent page and the child webpages which are related to each other may include matching or similar text. For example, the table below shows content searched by the user, a parent page and the child pages. As can be seen, the URLs of some of the child pages have matching/similar text as that of parent page and therefore such pages may be treated as related webpages.

| Content | | |
|---|---|---|
| searched | URL of the Parent Page | URLs of the child pages |
| Australia | https://en.wikipedia.org/wiki/ | https://en.wikipedia.org/ |
| and Europe | Australia%E2%80%93European_ | wiki/Australia |
| relations | Union_relations | https://en.wikipedia.org/ |
| | | wiki/China |
| | | https://en.wikipedia.org/ |
| | | wiki/Australia_in_the_ |
| | | Eurovision_Song_Contest |
| | | http://ec.europa.eu/trade/ |
| | | policy/countries-and- |
| | | regions/countries/australia/ |
| | | https://en.wikipedia.org/ |
| | | wiki/European_Union |
| | | https://en.wikipedia.org/ |
| | | wiki/European_Australians |

In an example embodiment, if URLs of multiple webpages contain similar/matching text, there is a high chance that the webpages relate to similar content. For example, the user opens three webpages having the following URLs: As can be seen, all the uniform resource locators (URL 1, URL 2 and URL 3) include text like GANDHI and INDEPENDENCE and therefore can be considered as related webpages.

| | |
|---|---|
| URL 1 | http://www.historytoday.com/benjamin-zachariah/gandhi-non- |
| | violence-and-indian-independence |
| URL 2 | http://www.india.com/top-n/mahatma-gandhi-jayanti-2016-top-5- |
| | movements-for-independence-by-the-father-of-the-nation-162192/ |
| URL 3 | http://timesofindia.indiatimes.com/home/sunday-times/Where-was- |
| | Mahatma-Gandhi-on-Independence-Day/articleshow/1200194.cms |

The presence of at least one matching or similar text in the title and/or heading extracted from a DOM tree structure can be explained with the following example. In this example, the user opens four webpages having the following uniform resource locators

| | | Title/Heading extracted |
|---|---|---|
| | | from a DOM tree |
| | URL | structure |
| URL 1 | http://www.samsung.com/in/ | history, Samsung, about |
| | aboutsamsung/samsung/history.html | Samsung, Samsung |
| URL 2 | http://www.samsung-mobiles.net/ | history of Samsung, |
| | history-of-samsung.html | Samsung mobiles |
| URL 3 | http://www.streetdirectory.com/travel_ | street directory, travel |
| | guide/116664/electronics/the_history_ | guide, electronics, the |
| | of_samsung.html | history of Samsung |
| URL 4 | https://en.wikipedia.org/wiki/Samsung | Samsung, wiki, |
| | | Wikipedia |

In the above example, the search for the matching text is conducted in title/heading extracted from the DOM tree. As seen, the title/heading extracted from the DOM tree of URL 1, URL 2 and URL 3 includes the same text like HISTORY and SAMSUNG. Hence, webpages having URL 1, URL 2 and URL 3 may be identified as related webpages. With respect to URL 4, the title/heading extracted from the DOM tree of URL 4 includes only the text SAMSUNG and not HISTORY. However, the content related to the URL 4 may include the text HISTORY and, therefore, may also be considered a related webpage. If we conduct a search for matching/similar text only in the URLs of the webpage and/or the title/heading of the DOM Tree, URL 4 may not be considered a related webpage. However, the webpage corresponding to URL 4 is a related webpage. In order to cover such embodiments, the present disclosure discloses further parsing of the DOM tree at the next level, i.e. conducting a search for the matching/similar text under the content of the titles/heading and includes such text while determining/identifying related webpages. By conducting such a search, URL 4 may also be categorized under the same group as URL 1, URL 2 and URL 3 (i.e. related webpages.)

The extraction of one or more key points (e.g., keywords) from webpages, as illustrated at operation 302, can be performed through one or more methods and/or algorithms already known in the art. Such methods include natural language processing (NLP), web scraping, DOM parsing, summarization and semantic analysis. It is to be understood that methods other than those mentioned above may also be used for extraction of one or more key points from the webpages.

The comparison of one or more key points, as illustrated at operation 303, can be through one or more methods and/or algorithms already known in the art. Such methods include point-to-point comparison, textual paragraph/summary comparison and multimedia comparison. It is to be understood that methods other than those mentioned above may also be used for comparison of key points extracted from one or more webpages.

The user input pattern as illustrated at operation 304 may include: (a) closing the one or more webpages, (b) switching between webpages, (c) opening one or more webpages, (d) navigating within the webpage, and (e) switching between web browser windows.

The functionality provided to the user on closing one or more webpages may include one or more of: (a) closing all the webpages, (b) saving all the webpages, (c) printing all the webpages, (d) emailing all the webpages, (e) copying all the webpages, (f) saving highlighted key points in the webpages, (g)printing highlighted key points in the webpages, (h) emailing highlighted key points in the webpages, (i) copying highlighted key points in the webpages, (j) saving the webpages having highlighted key points, (k) printing the webpages having highlighted key points, (1) copying the webpages having highlighted key points, (m) emailing the webpages having highlighted key points, (n) saving the webpages having the maximum number of key points, (o) printing the webpages having maximum number of key points, (p) copying the webpages having the maximum number of key points, (q) emailing the webpages having maximum number of key points, (r) saving a first set of webpages having all the key points, (s) emailing a first set of webpages having all the key points, (t) copying a first set of webpages having all the key points, and (u) printing a first set of webpages having all the key points.

The functionality provided to the user on switching between webpages, opening one or more webpages, navigating within the webpage or switching between web browser windows may include one or more of: (a) highlighting one or more key points on a current webpage, the one or more key points absent in one or more previously accessed and webpages, (b) displaying, on a current webpage, only the one or more key points absent in one or more previously accessed webpages, (c) auto-scrolling to one or more key points on a current webpage, the one or more key points absent in one or more previously accessed and webpages, (d) navigating to one or more key points on a current webpage, the one or more key points absent in one or more accessed and webpages, (e) highlighting one or more key points on a current webpage, the one or more key points present in one or more previously accessed and webpages, (f) displaying, on a current webpage, only the one or more key points present in one or more previously accessed webpages, (g) auto-scrolling to one or more key points on a current webpage, the one or more key points present in one or more previously accessed and webpages, (h) navigating to one or more key points on a current webpage, the one or more key points present in one or more accessed and webpages, (i) highlighting one or more key points on a current webpage, the one or more key points browsed in one or more previously accessed and webpages, (j) displaying, on a current webpage, only the one or more key points browsed in one or more previously accessed webpages, (k) auto-scrolling to one or more key points on a current webpage, the one or more key points browsed in one or more previously accessed and webpages, (l) navigating to one or more key points on a current webpage, the one or more key points browsed in one or more accessed and webpages, (m) highlighting one or more key points on a current webpage, the one or more key points un-browsed in one or more previously accessed and webpages, (n) displaying, on a current webpage, only the one or more key points un-browsed in one or more previously accessed webpages, (o) auto-scrolling to one or more key points on a current webpage, the one or more key points un-browsed in one or more previously accessed and webpages, (p) navigating to one or more key points on a current webpage, the one or more key points un-browsed in one or more accessed and webpages, (q) creating a virtual page corresponding to a current webpage, the virtual page displaying one or more key points absent in one or more previously accessed and webpages.

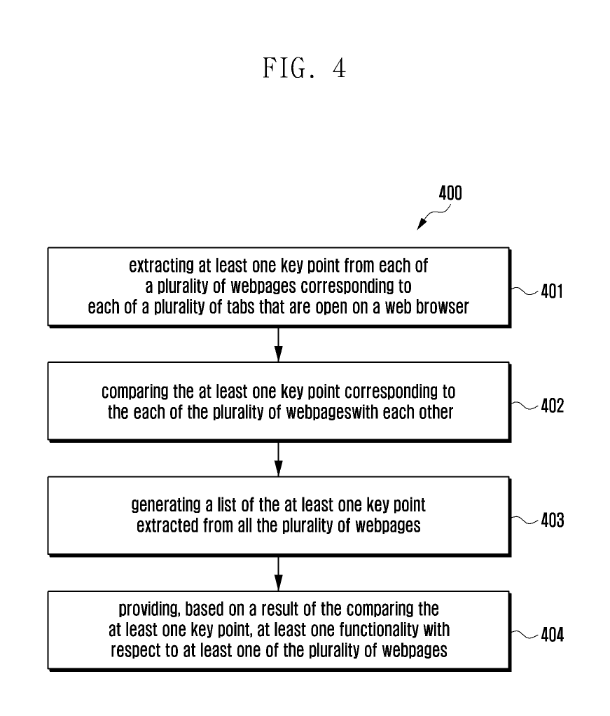

FIG. 4 illustrates a method 400 for providing at least one functionality to the user with respect to at least one of the plurality of the webpages, in accordance with an example embodiment.

At operation 401, at least one key point (e.g., keywords) corresponding to each of the webpages are extracted from each of the plurality of webpages. Content of each webpage may be analyzed to extract the key points corresponding to each of the webpages. A user may select webpages through a web browser to open the webpages in multiple tabs the web browser. For example, each of the plurality of webpages may correspond to each of a plurality of tabs that are open on a web browser.

At operation 402, the at least one key point corresponding to the plurality of webpages may be compared to each other.

At operation 403, a list of the at least one key point extracted from all the webpages may be generated.

At operation 404, based on a result of comparing the key points, at least one functionality may be provided to a user with respect to at least one of the plurality of webpages.

The method 400 may further include, based on a predetermined criterion, identifying whether the plurality of webpages are related to each other. Related webpages may share common topics, keywords, formats, content, etc. The relatedness of websites may be determined based on a number of shared topics, keywords, etc. and threshold value.

The method further includes dynamically updating the at least one functionality based on one or more of: interaction with currently opened webpage; and detection of a new related webpage.

The predetermined criterion for identifying a plurality of webpages as depicted at operation 401 includes presence of at least one matching or similar text in one or more of: (a) URLs of the webpages, (b) titles of the webpages and/or content thereof, the titles extracted from a DOM tree structure created for each webpage, (c) headings of the webpages and/or content thereof, the headings extracted from the DOM tree structure created for each webpage, and (d) metadata within the webpages. The same has been explained in detail while explaining the predetermined criterion for identifying a plurality of webpages at operation 302.

The extraction of one or more key points from webpages, as illustrated at operation 402, can be through one or more methods and/or algorithms already known in the art. Such methods include natural language processing (NLP), web scraping, DOM parsing, summarization and semantic analysis. It is to be understood that methods other than those mentioned above may also be used for extraction of one or more key points from the webpages.

The comparison of one or more key points, as illustrated at operation 403, can be performed through one or more methods and/or algorithms already known in the art. Such methods include point-to-point comparison, textual paragraph and multimedia comparison. It is to be understood that methods other than those mentioned above may also be used for comparison of key points extracted from one or more webpages.

The operation of providing at least one functionality to the user may include one or more of : (a) highlighting one or more webpages having a maximum number of the unique key points from the list of unique key points, (b) sorting webpages in a descending order, a first webpage in the order having a maximum number of the unique key points and a last webpage in the order having a minimum number of unique key points, (c) sorting webpages in an ascending order, a first webpage in the order having a minimum number of unique key points and a last webpage in the order having a maximum number of unique key points, (d) automatically switching to a webpage having a maximum number of the unique key points from the list of unique key points, (e) auto-navigate from a webpage having a maximum number of unique key points to one or more webpage having remaining number of key points, (f) indicating one or more minimum navigational paths, the minimum navigational path indicating a webpage having maximum number of unique key points from the list of unique key points and at least one webpage having a remaining number of unique key points, (g) auto-closing one or more webpages not indicated in a minimum navigational path, the minimum navigational path indicating a webpage having maximum number of unique key points from the list of unique key points and at least one webpage having a remaining number of unique key points, (h) dynamically sorting the webpages other than a current webpage in a descending order, a first webpage in the order having a maximum number of remaining key points and a last webpage having a minimum number of remaining key points, (i) dynamically sorting the webpages other than a current webpage in an ascending order, a first webpage in the order having a minimum number of remaining key points and a last webpage having a maximum number of remaining key points, and (j) grouping at least one set of webpages from amongst the plurality of webpages such that the first set of webpages includes all the unique key points. It is to be understood that the set is not a null set and may include at least two webpages. Further, if more than one set occurs, the sets can be visually distinguished from each other. The options for visually distinguishing them include one or more of: font changes, effects, color change and the like. The operation of providing at least one functionality to the user may also include (k) grouping at least one set of webpages from amongst the plurality of webpages such that the first set of webpages includes all the key points and are sorted in a predetermined order. It is to be understood that the predetermined order include an ascending order or a descending order. Further, if more than one set occurs, the sets can be visually distinguished from each other. The options for visually distinguishing the sets may include one or more of: font changes, effects, color change and the like.

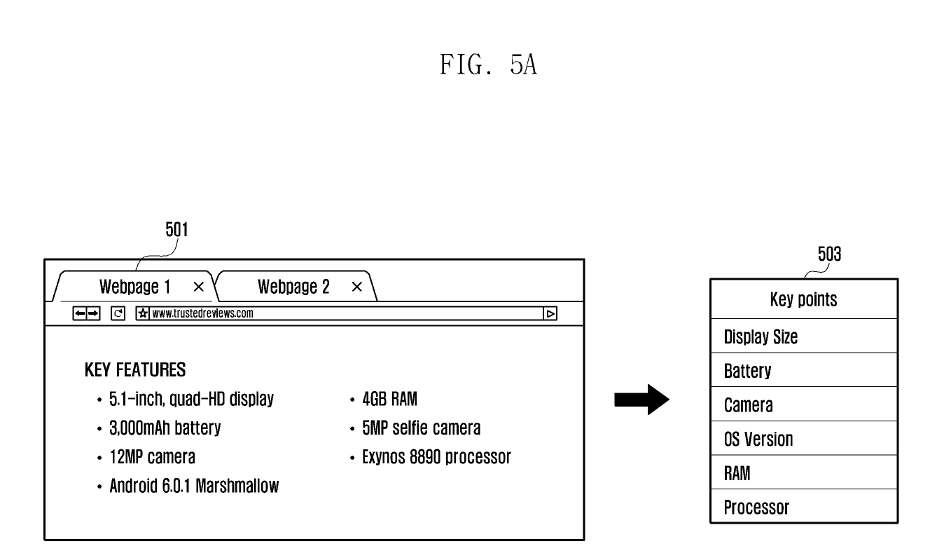

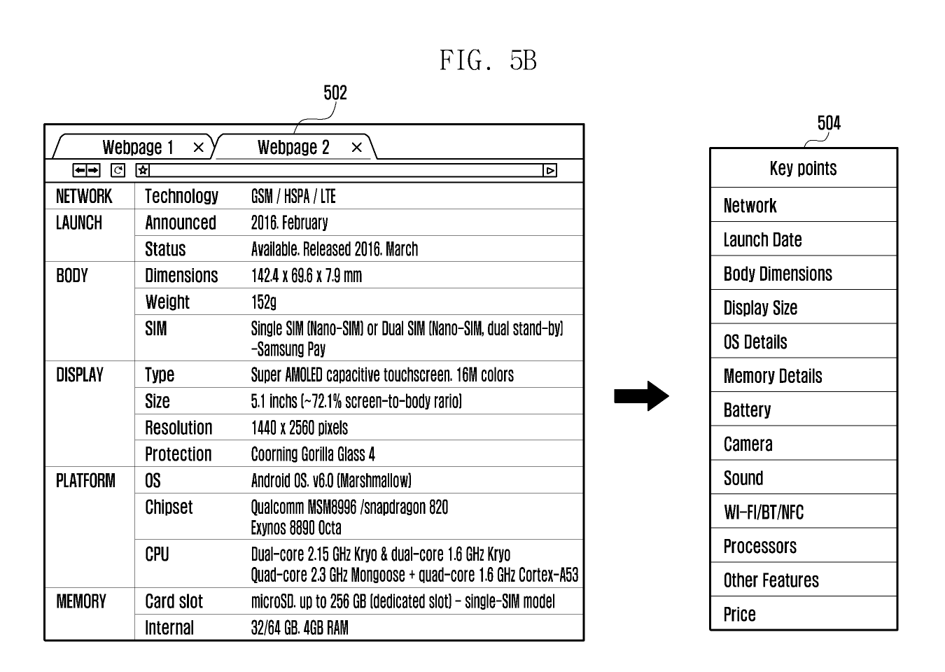

FIGS. 5A and 5B illustrate the extraction of key points from related webpages as described at operations 302 and 402 of methods 300 and 400, respectively, in accordance with an example embodiment. As shown, key points 503 and 504 are extracted from webpages 501 and 502 respectively.

FIG. 5A illustrates webpage 501 and key points 503 extracted from the webpage 501. FIG. 5B illustrates webpage 502 and key points 504 extracted from the webpage 502. As already mentioned, the extraction of key points can be performed through one or more methods and/or algorithms already known in the art. Such methods include natural language processing (NLP), web scraping, DOM parsing, summarization and semantic analysis. It is to be understood that methods other than those mentioned above may also be used for extraction of one or more key points from the related webpages.

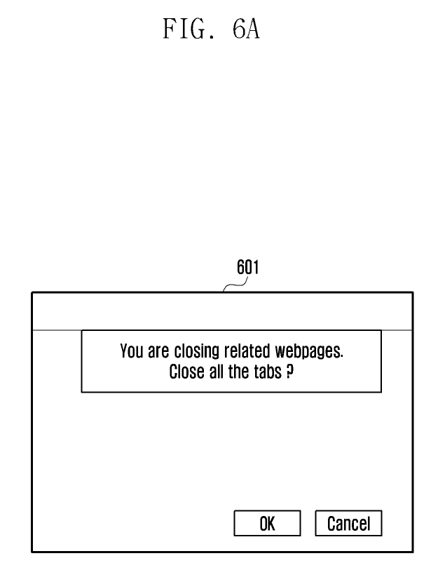

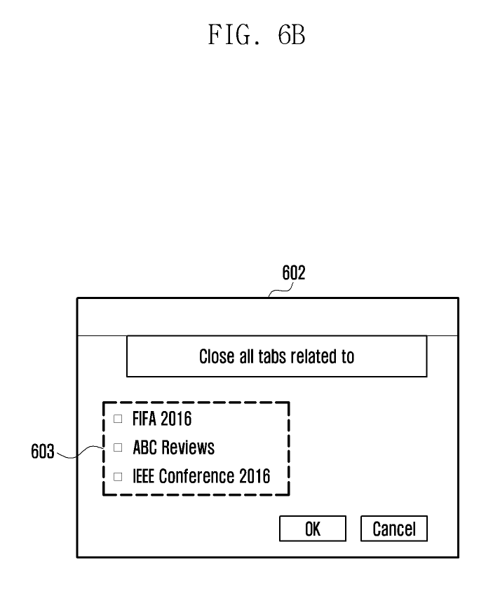

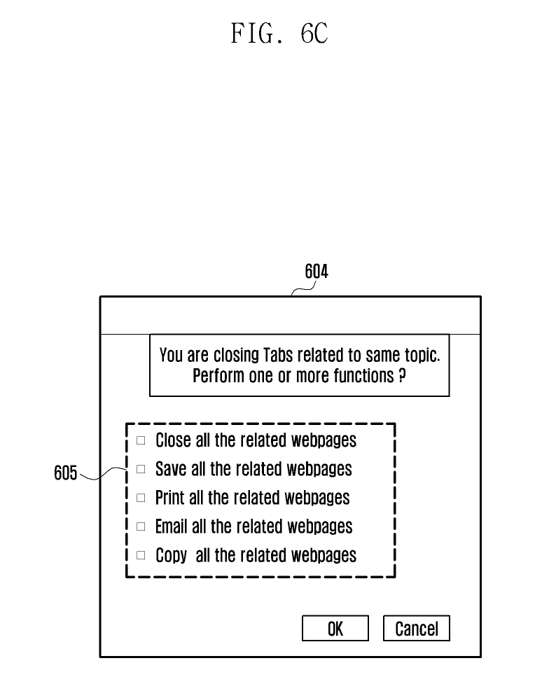

FIGS. 6A to 6C illustrate functionalities provided to the user on closing one or more related webpages, in accordance with an example embodiment.

When a user is done browsing content on a topic, the user may manually close all the tabs/links opened related to that topic. This is currently a manual task in which user needs to close each individual link/tab. The present disclosure will identify this pattern and will provide an option to user to automatically perform one or more functions.

FIG. 6A illustrates a user interface 601 providing an option to close all the related webpages corresponding to the same topic. It is to be understood that similar user interfaces can be provided to the user to save, print, copy and email all the related webpages corresponding to the same topic. FIG. 6B illustrates a user interface 602 providing an option to close all the related webpages corresponding to a plurality of topics 603. It is to be understood that similar user interfaces can be provided to the user to save, print, copy and email all the related webpages corresponding to a plurality of topics. FIG. 6C illustrates a user interface 604 providing option to select one or more functionalities 605 in relation to the related webpages. As shown, the functionalities 605 include closing, copying, saving, printing and emailing all the related webpages.

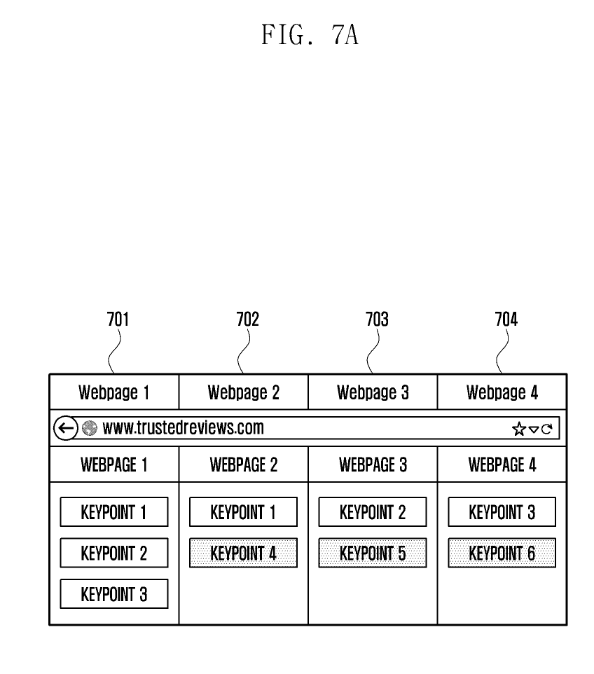

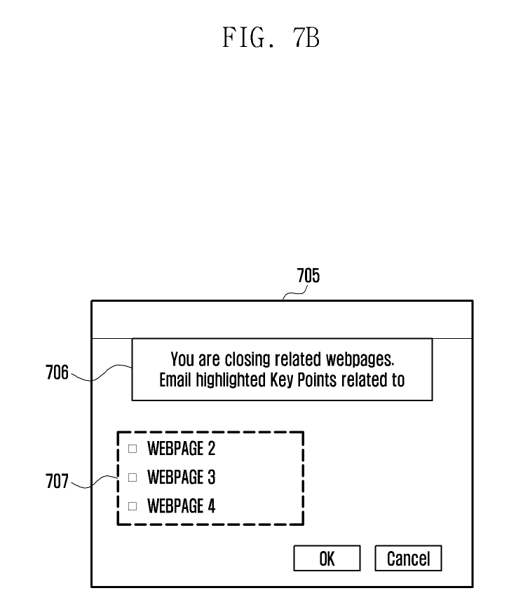

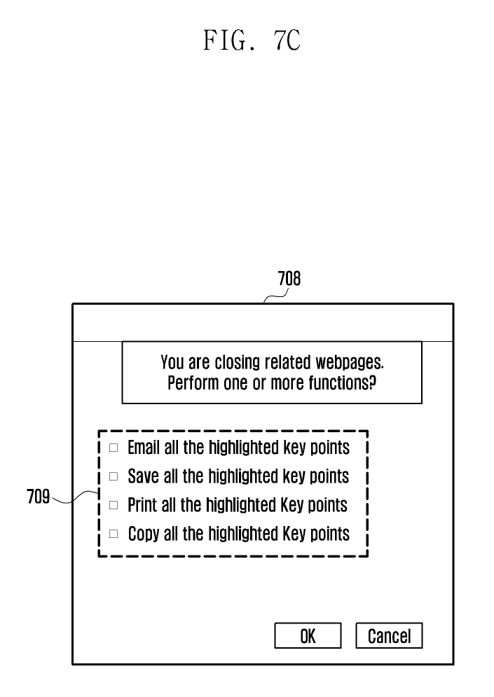

FIGS. 7A to 7C illustrate functionalities provided to the user on closing one or more related webpages, in accordance with an example embodiment.

FIG. 7A illustrates related webpages 701, 702, 703 and 704. The key points related to each webpage are also shown. When the user successively accesses the webpages 701, 702, 703 and 704, new information present on each webpage may be highlighted, as depicted in FIG. 7A as shaded boxes. When the user closes one or more of the related webpages 701, 702, 703 and 704, the present disclosure provides a user interface, the user interface providing an option to select one or more functionalities. FIG. 7B illustrates a user interface 705 wherein functionality 706 to email highlighted key points of one or more webpages (707) is provided to the user. It is to be understood that other functionalities including copying, printing, saving all the highlighted key points may also be provided to the user. FIG. 7C illustrates another user interface 708 wherein a plurality of functionalities 709 are provided to the user in relation to the highlighted key points. As shown by reference numeral 709, the functionalities include copying, printing, saving and emailing all the unique key points.

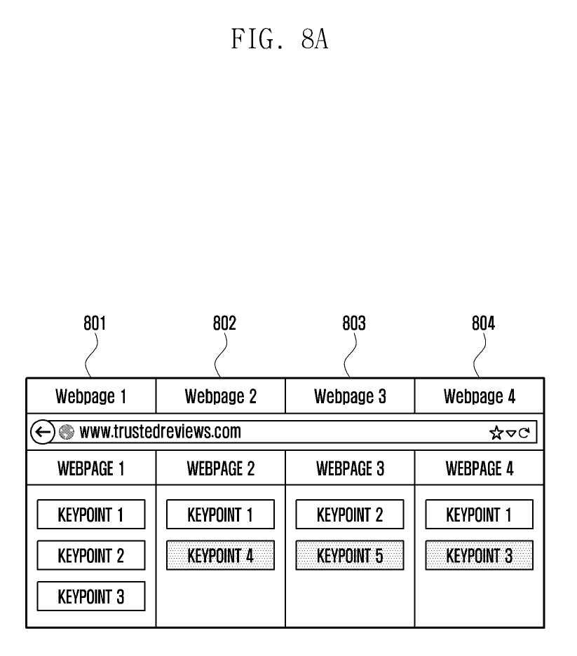

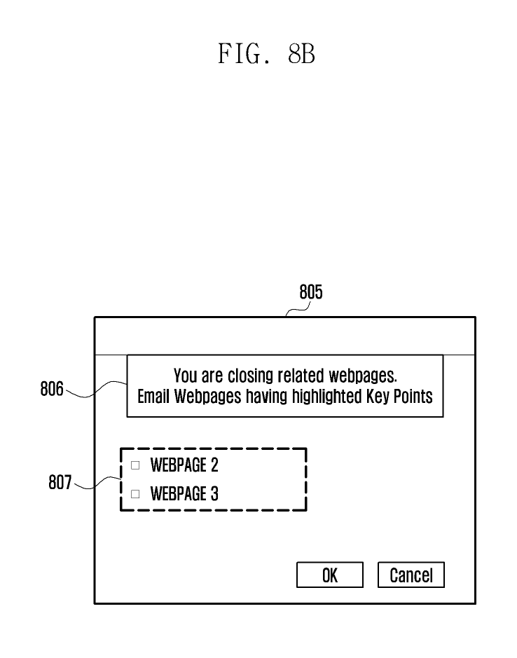

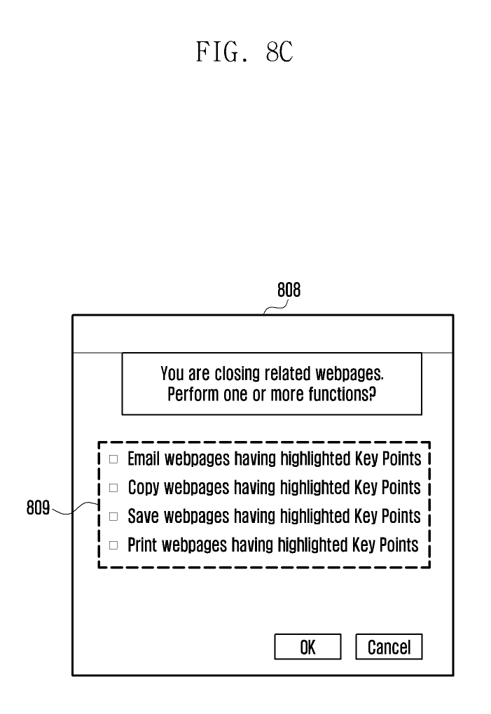

FIGS. 8A to 8C illustrate functionalities provided to the user on closing one or more related webpages, in accordance with an example embodiment.

FIG. 8A illustrates related webpages 801, 802, 803 and 804. The key points related to each webpage are also shown. When the user successively accesses the webpages 801, 802, 803 and 804, new information present on each webpage may be highlighted, as depicted in FIG. 8A as shaded boxes. As can be seen, no new key points are present on webpage 804. When the user closes one or more of the related webpages 801, 802, 803 and 804, the present disclosure provides a user interface, the user interface providing an option to select one or more functionalities. FIG. 8B illustrates a user interface 805 wherein functionality 806 to email one or more webpages 807 having highlighted key points is provided to the user. As no highlighted key point is present on webpage 804, such functionality is not provided in relation to webpage 804. It is to be understood that other functionalities including copying, printing, saving one or more webpages having highlighted key points may also be provided to the user. FIG. 8C illustrates another user interface 808 wherein a plurality of functionalities 809 are provided to the user in relation to webpages having highlighted key points. As shown by reference numeral 809, the functionalities include copying, printing, saving and emailing webpages having unique key points.

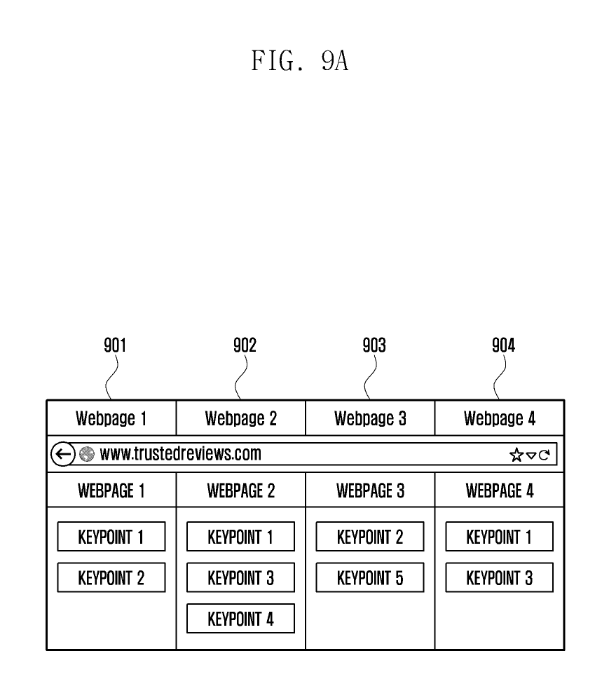

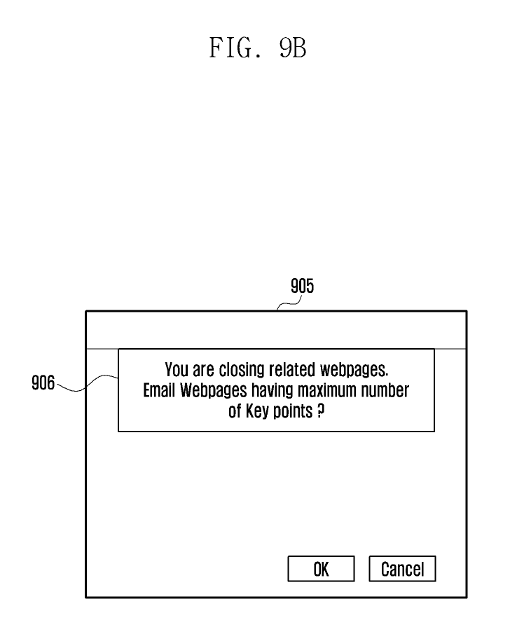

FIGS. 9A and 9B illustrate functionalities provided to the user on closing one or more related webpages, in accordance with an example embodiment.

FIG. 9A illustrates related webpages 901, 902, 903 and 904. The key points related to each webpage are also shown. As can be seen, the webpage 902 has the maximum number of key points. When the user closes one or more of the related webpages 901, 902, 903 and 904, the present disclosure provides a user interface, the user interface providing an option to select one or more functionalities. FIG. 9B illustrates a user interface 905 wherein functionality 906 to email one or more webpages having maximum number of key points is provided to the user. As maximum number of key point is present on webpage 902, such functionality is provided in relation to webpage 902. It is to be understood that other functionalities including copying, printing, saving webpages having maximum number of highlighted key points can also be provided to the user.

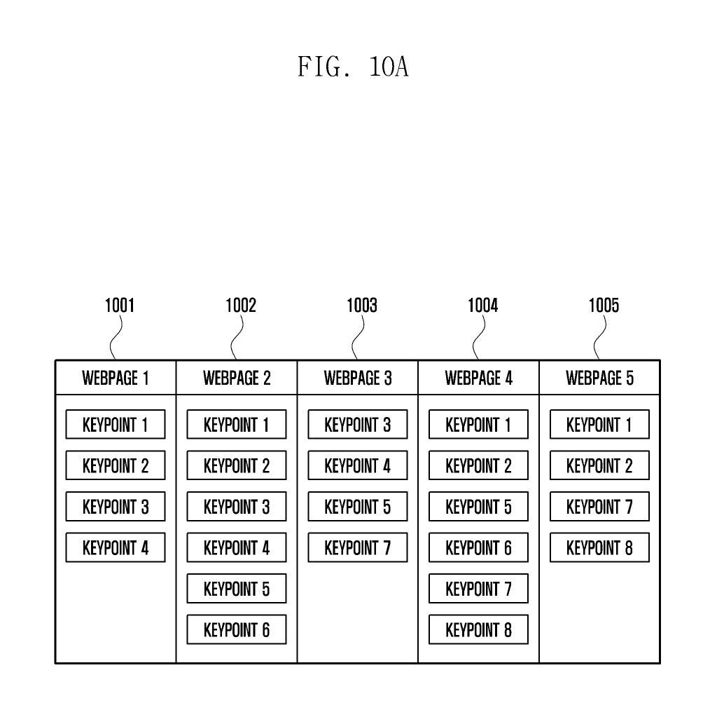

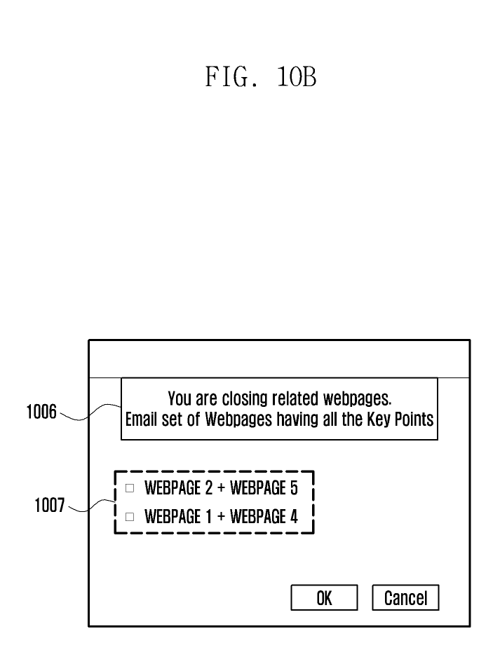

FIGS. 10A and 10B illustrate functionalities provided to the user on closing one or more related webpages, in accordance with an example embodiment.

FIG. 10A illustrates related webpages represented by reference numerals 1001, 1002, 1003, 1004 and 1005. The key points related to each webpage are also shown. When the user closes one or more of the related webpages 1001, 1002, 1003, 1004 and 1005, the present disclosure provides a user interface, the user interface providing an option to select one or more functionalities. FIG. 10B illustrates a user interface 1006 wherein functionality 1007 is provided to the user. The functionality 1007 corresponds to emailing one or more sets of related webpages, the sets having the minimum number of webpages having all the key points. As can be seen, a combination of webpage 2 and webpage 5 and a combination of webpage 1 and 4 have all the key points and the user will have to browse only two websites in each case. It is to be understood that other functionalities including copying, printing, saving can also be provided for sets of related webpages having all the key points.

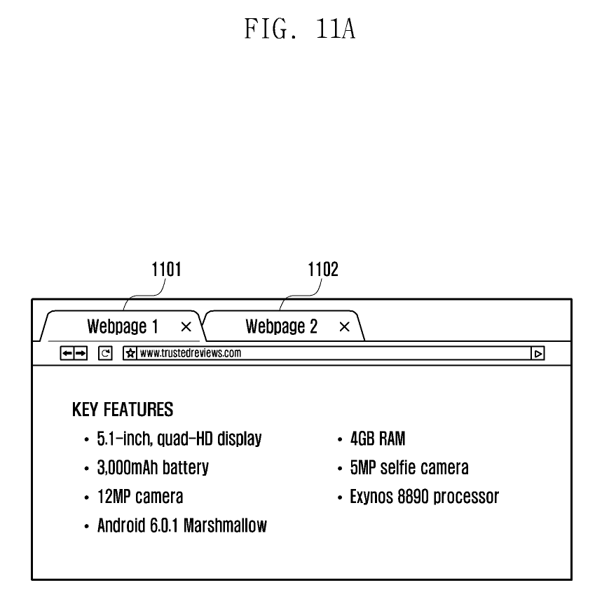

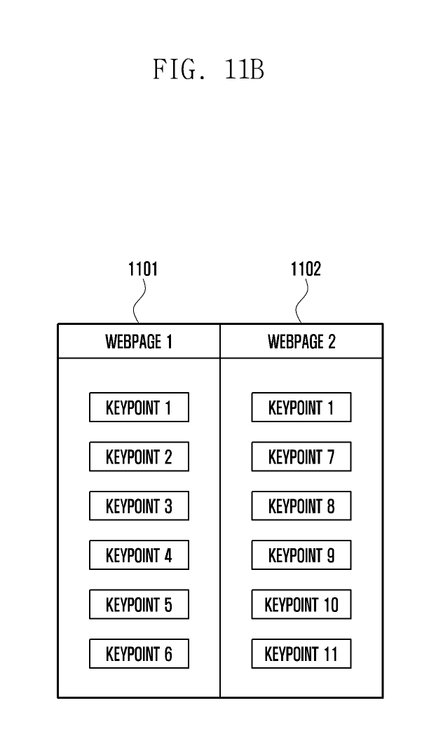

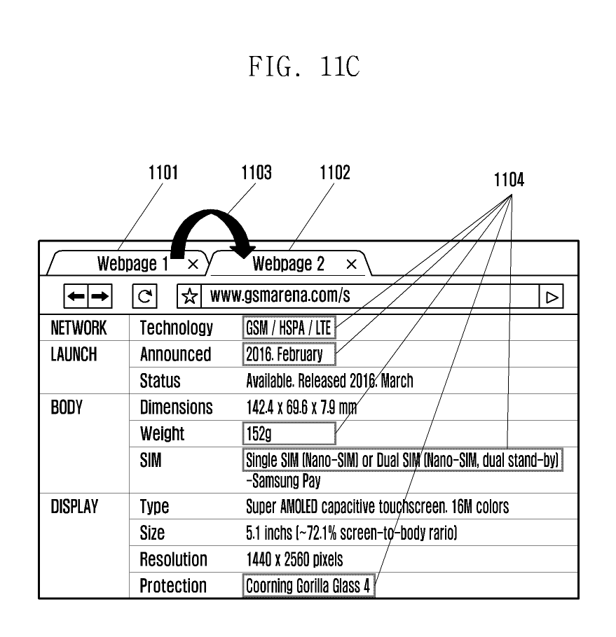

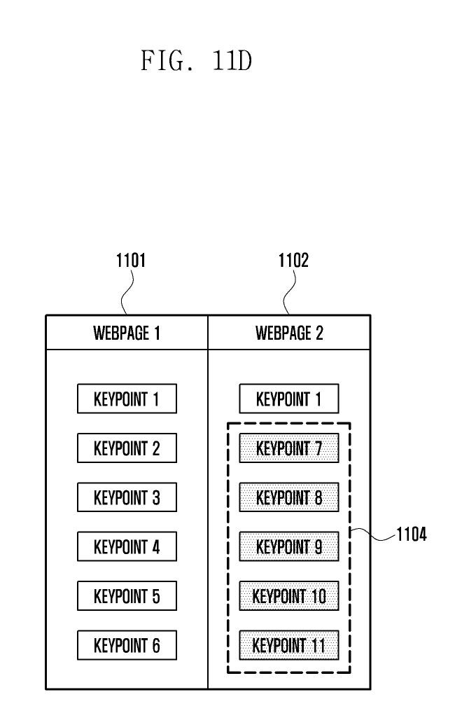

FIGS. 11A to 11D illustrate functionalities provided to the user wherein the user pattern is one of: switching between related webpages, opening one or more related webpages, navigating within the related webpages and switching between web browser windows, in accordance with an example embodiment.

FIG. 11A illustrates webpages 1101 and 1102. FIG. 11B illustrates tabular form displaying key points on each related webpages 1101 and 1102. FIG. 11C illustrates the switching 1103 of user from webpage 1101 to the webpage 1102. As shown, the present disclosure provides functionality wherein key points absent in the webpage 1101 are highlighted on webpage 1102. The highlighted key points have been depicted by reference numeral 1104 in FIG. 11C. The same is depicted in FIG. 11D wherein, when the user switches from the webpage 1101 to webpage 1102, the new key points in webpage 1102 (i.e. key points absent in webpage 1101) are highlighted (1104). In other words, new information/key points present on webpage 1102 is highlighted. In an embodiment, instead of highlighting the new information/ key points on page 1102, the browser may auto-scroll/auto navigate on the new information/key points present on webpage 1102. When the user switches from webpage 1101 to webpage 1102, only the new key points in webpage 1102 may be displayed (i.e. key points 7, 8 ,9, 10 and 11 are displayed and not key point 1).

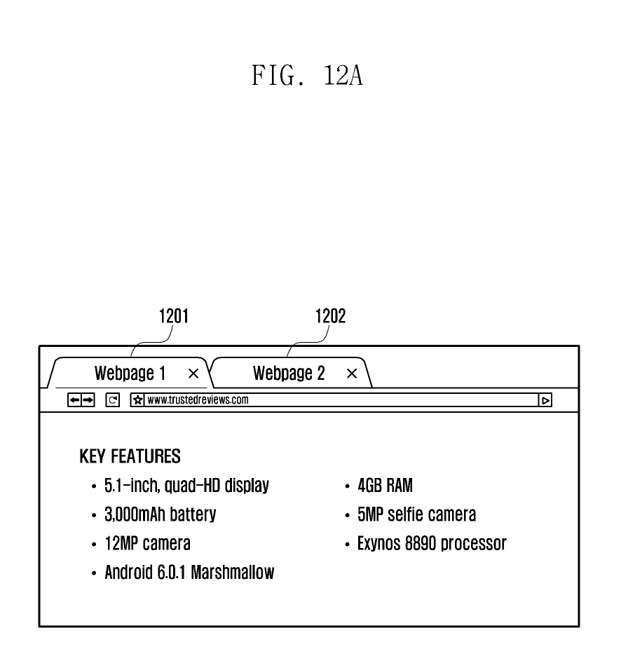

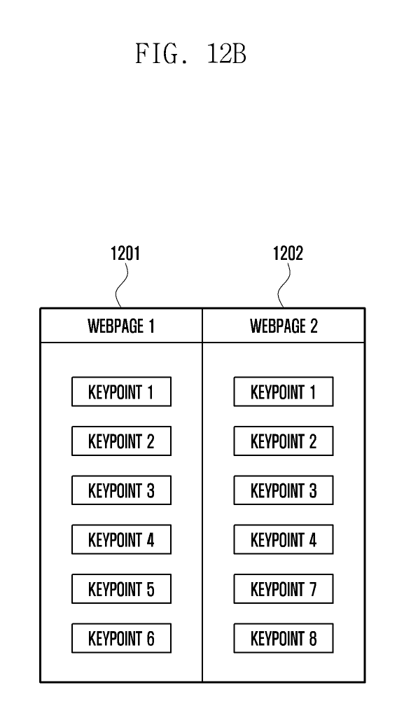

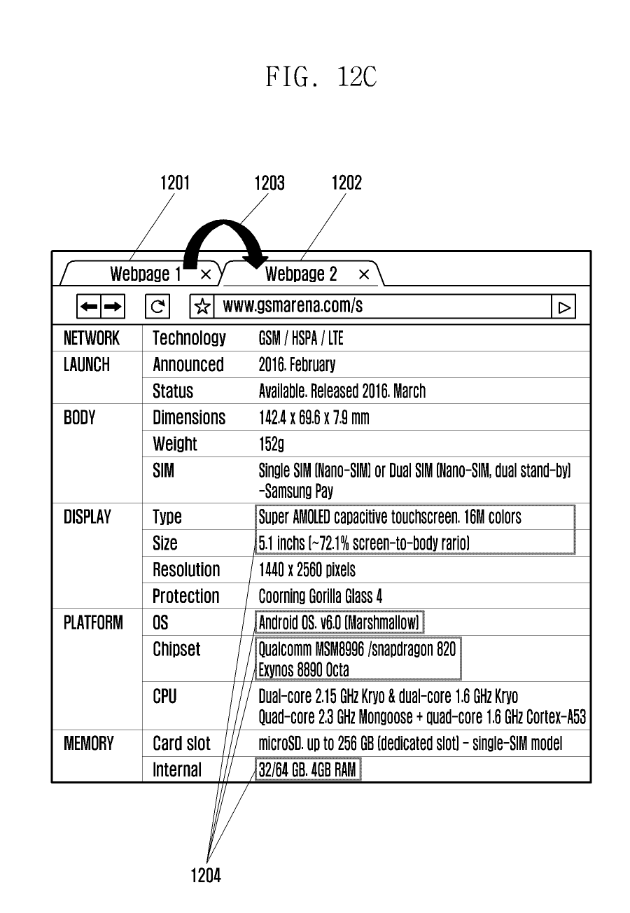

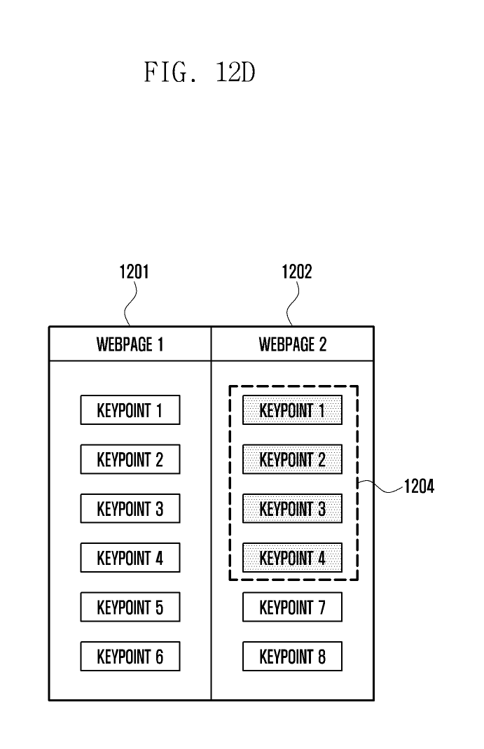

FIGS. 12A to 12D illustrate functionalities provided to the user wherein the user pattern is one of: switching between related webpages, opening one or more related webpages, navigating within the related webpages and switching between web browser windows, in accordance with an example embodiment.

FIG. 12A illustrates webpages 1201 and 1202. FIG. 12B illustrates tabular form displaying key points on each related webpages 1201 and 1202. FIG. 12C illustrates the switching 1203 by the user from webpage 1201 to webpage 1202. As shown, the present disclosure provides functionality wherein key points present in the webpage 1201 are highlighted on webpage 1202. The highlighted key points have been depicted by reference numeral 1204 in FIG. 12C. The same is depicted in FIG. 12D wherein, when the user switches from webpage 1201 to webpage 1202, the key points present in webpage 1201 are highlighted (1204) in webpage 1202. In other words, only those key points are highlighted in webpage 1202 which are already present in webpage 1201. Instead of highlighting the information/ key points on page 1202, the browser may auto-scroll/auto navigate on the information/key points present on webpage 1202. When the user switches from webpage 1201 to webpage 1202, only the key points present in webpage 1201 may be displayed in webpage 1202 (i.e. key points 1, 2, 3, and 4 are displayed and not key point 7 and 8).

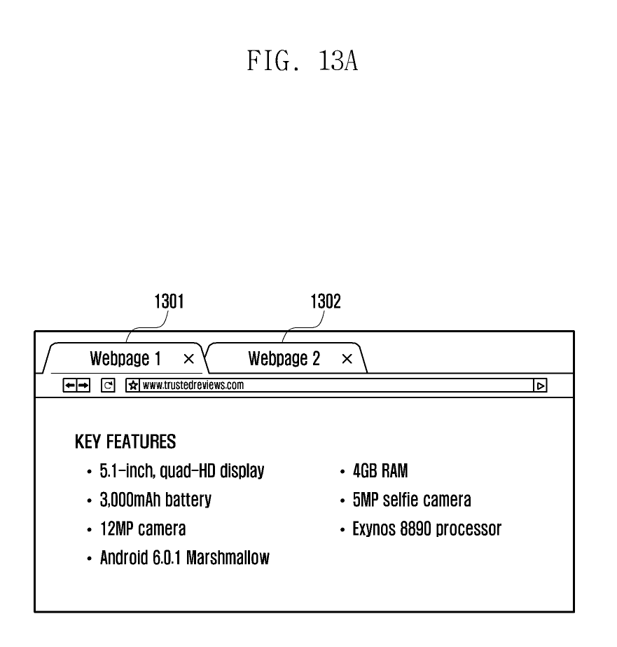

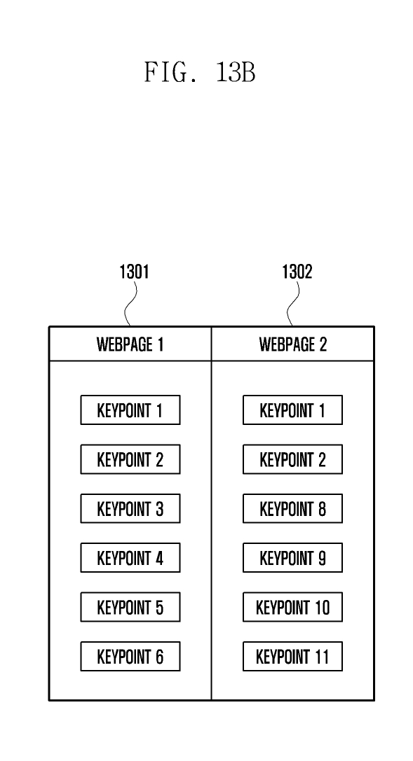

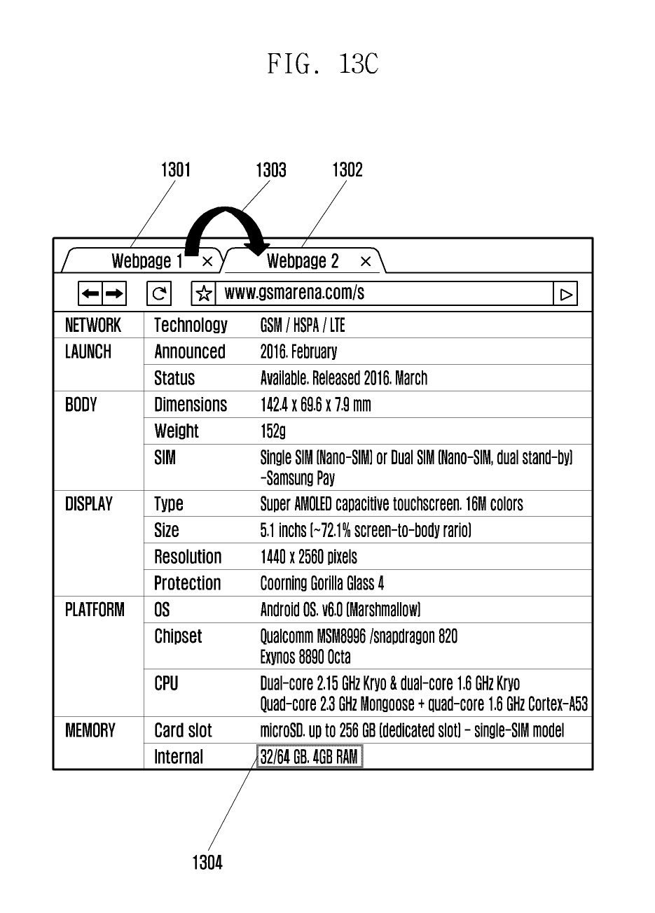

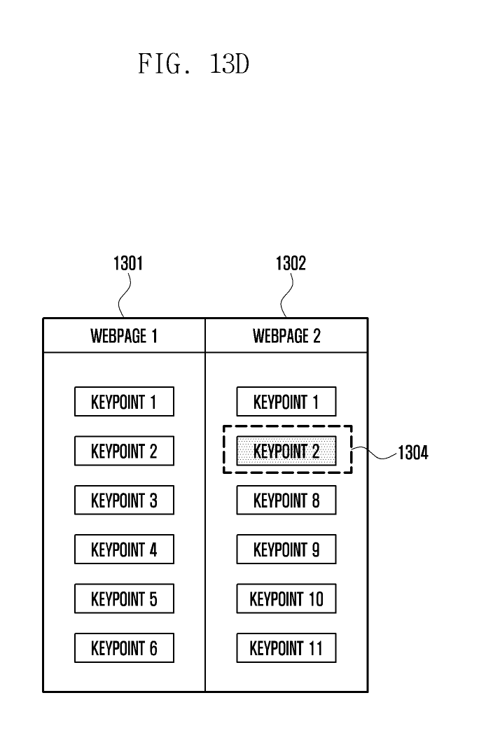

FIGS. 13A to 13D illustrate functionalities provided to the user wherein the user pattern is one of: switching between related webpages, opening one or more related webpages, navigating within the related webpages and switching between web-browser windows, in accordance with an example embodiment.

FIG. 13A illustrates webpages 1301 and 1302. FIG. 13B illustrates tabular form displaying key points on each related webpages 1301 and 1302. FIG. 13C illustrates the switching 1303 by the user from webpage 1301 to webpage 1302. As shown, the present disclosure provides functionality wherein key points that are un-browsed by the user on the webpage 1301 are highlighted on webpage 1302. The highlighted key points have been depicted by reference numeral 1304 in FIG. 13C. The same is depicted in FIG. 13D wherein, when the user switches from webpage 1301 to webpage 1302, the un-browsed key points present in webpage 1301 are highlighted (1304) in webpage 1302. It can be seen that key point 2 is present in both webpage 1301 and 1302. However, as the key point 2 was not browsed by the user in webpage 1301, the same has been highlighted on webpage 1302. Instead of highlighting the information/ key points on page 1302, the browser may auto-scroll/auto navigate on the information/key points present on webpage 1302. When the user switches from webpage 1301 to webpage 1302, only the un-browsed key points present in webpage 1301 may be displayed in webpage 1302 (i.e. key point 2 is displayed and not the key points 1, 8, 9, 10, 11).

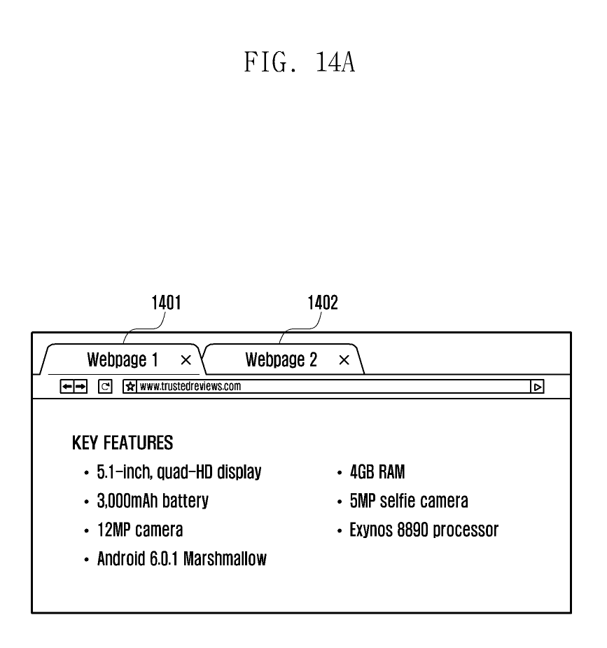

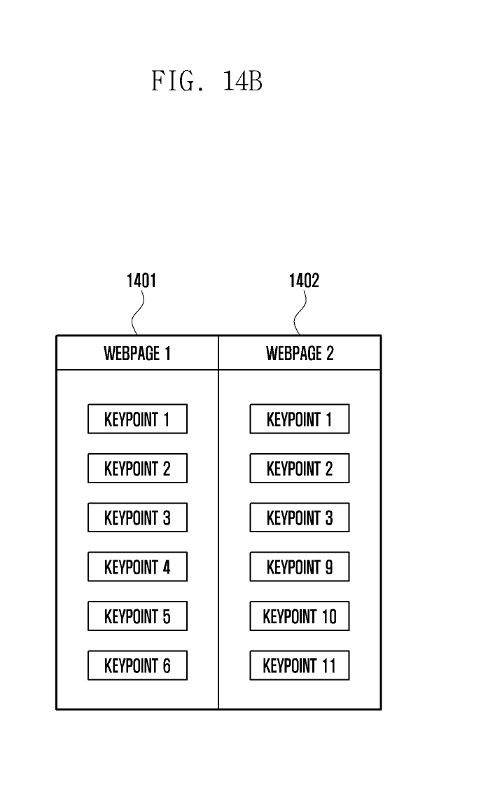

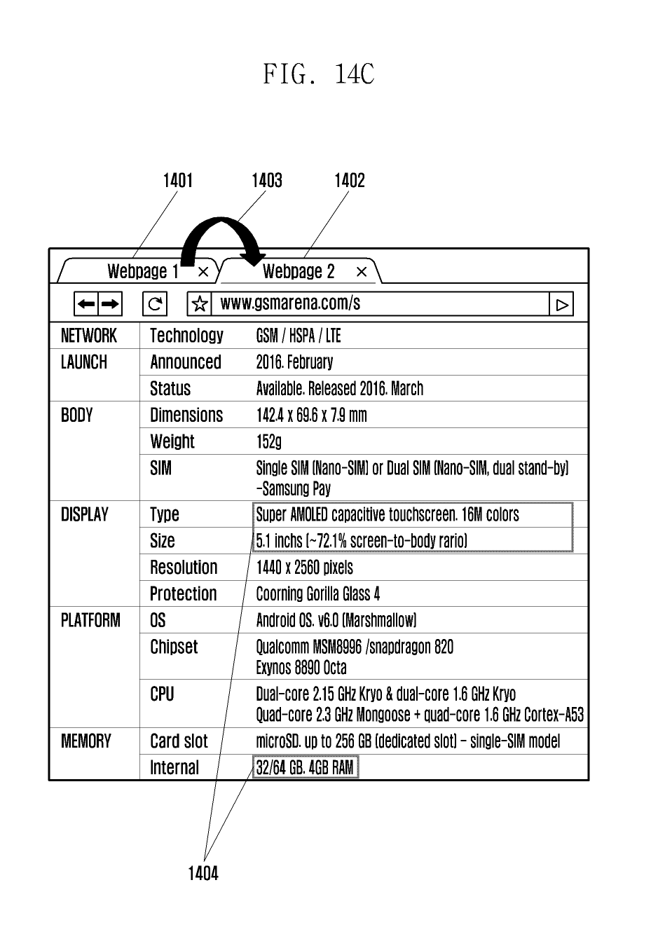

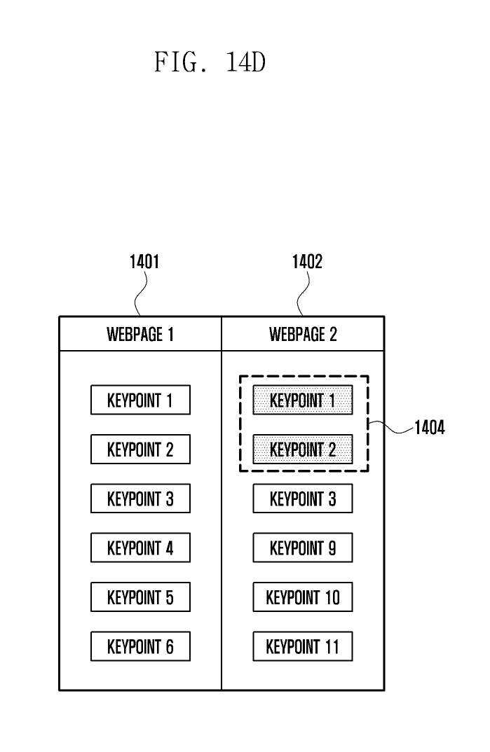

FIGS. 14A to 14D illustrate functionalities provided to the user wherein the user pattern is one of: switching between related webpages, opening one or more related webpages, navigating within the related webpages and switching between web-browser windows, in accordance with an embodiment of the present disclosure.

FIG. 14A illustrates webpages 1401 and 1402. FIG. 14B illustrates tabular form displaying key points on each related webpages 1401 and 1402. FIG. 14C illustrates the switching 1403 by the user from webpage 1401 to webpage 1402. As shown, the present disclosure provides functionality wherein key points that are browsed by the user on the webpage 1401 are highlighted on webpage 1402. The highlighted key points have been depicted by reference numeral 1404 in FIG. 14C. The same has depicted in FIG. 14D wherein, when the user switches from webpage 1401 to webpage 1402, the key points browsed by the user in webpage 1401 are highlighted (1404) in webpage 1402. It can be seen that key point 1, 2 and 3 are present in both webpage 1401 and 1402. However, the user browses only key point 1 and 2 on webpage 1401 and therefore when the user switched from webpage 1401 to webpage 1402, only the key points 1 and 2 may be highlighted and not the key point 3. Instead of highlighting the key points on page 1402, the browser may auto-scroll/auto navigate on the key points on webpage 1402. When the user switches from webpage 1401 to 1402, only the key points browsed by the user in webpage 1401 may be displayed in webpage 1402 (i.e. only key points 1 and 2 are displayed and not key points 3, 9, 10 and 11).

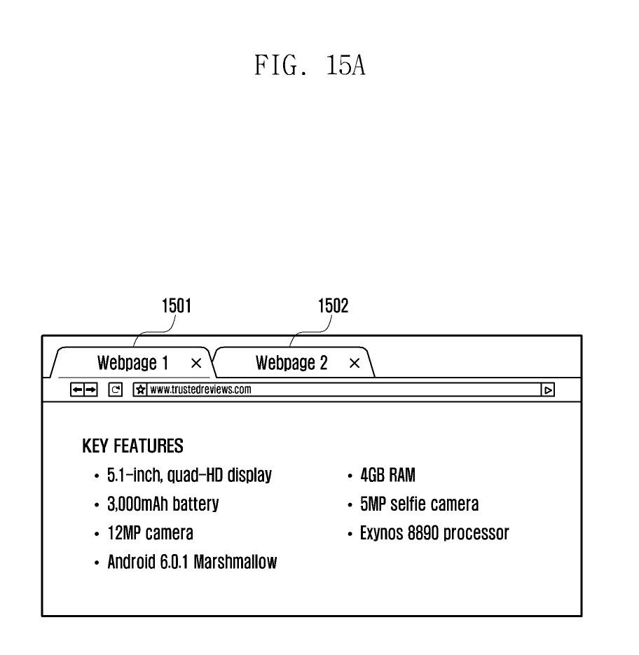

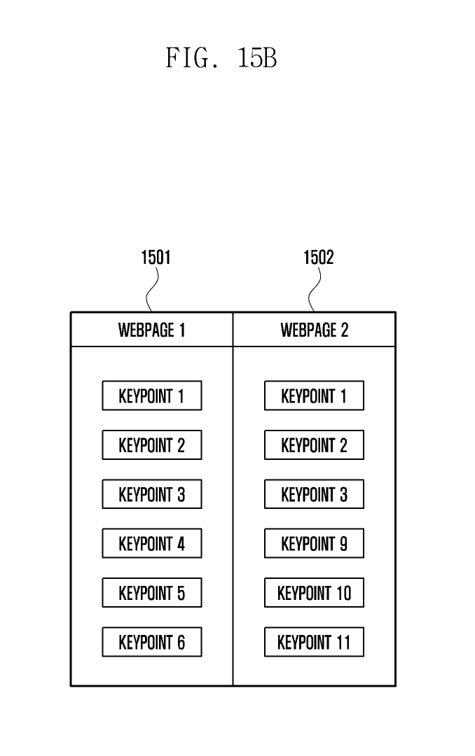

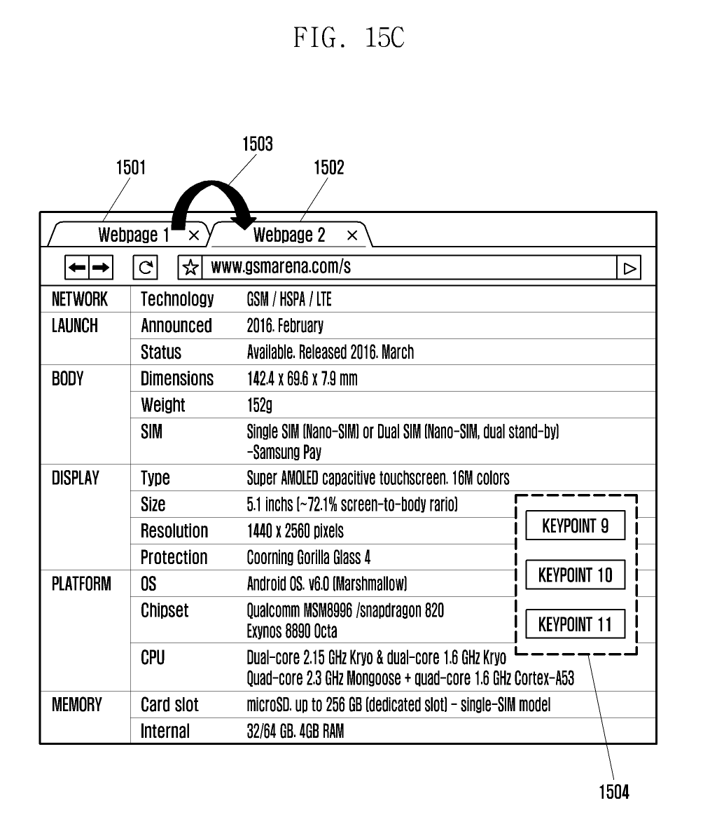

FIGS. 15A to 15C illustrate functionalities provided to the user wherein the user pattern is one of: switching between related webpages, opening one or more related webpages, navigating within the related webpages and switching between web-browser windows, in accordance with an embodiment of the present disclosure.

FIG. 15A illustrates webpages 1501 and 1502. FIG. 15B illustrates tabular form displaying key points on each related webpages 1501 and 1502. FIG. 15C illustrates the switching 1503 of user from webpage 1501 to 1502. As shown, the present disclosure provides functionality wherein a virtual page 1504 corresponding to a switched webpage 1502 is provided to the user, the virtual page 1504 displaying one or more key points absent in previously accessed webpage 1501.

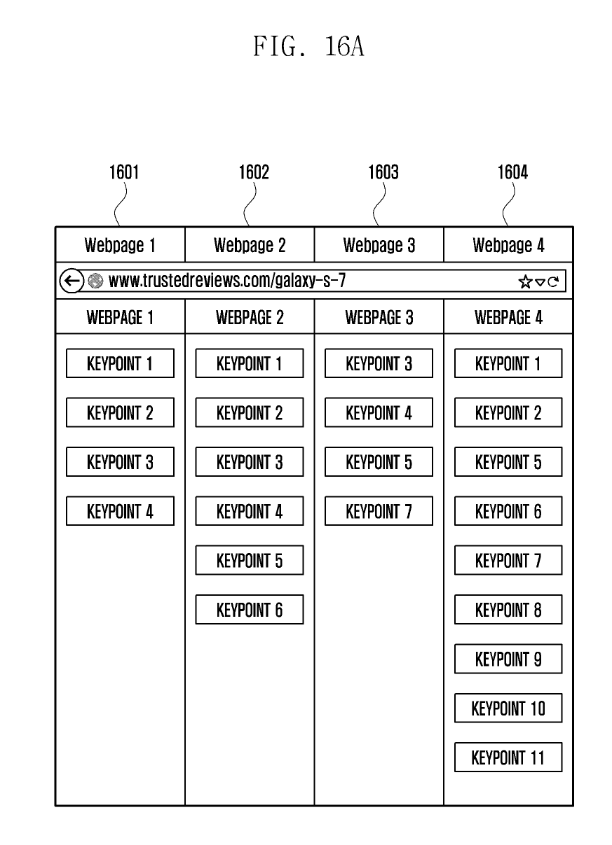

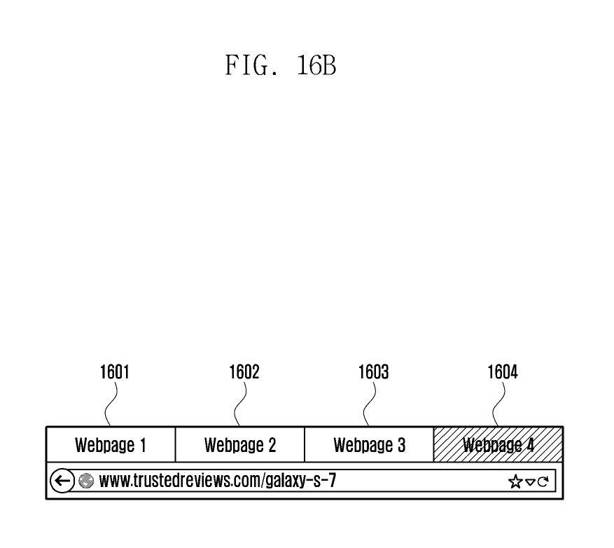

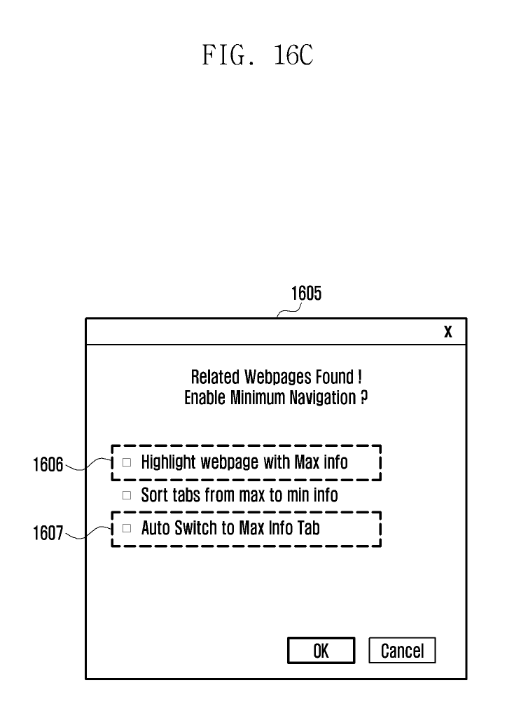

FIGS. 16A to 16C illustrate functionalities provided to the user, in accordance with an example embodiment.

FIGS. 16A to 16C illustrate the functionality wherein one or more related webpages having a maximum number of the unique key points from the list of unique key points are highlighted. FIG. 16A illustrates webpages 1601, 1602, 1603 and 1604 and key points related to each webpage. FIG. 16B illustrates that the webpage having the maximum number of key points (i.e. webpage 1604) is highlighted, as represented by the hashed lines in FIG. 16B. The present disclosure also allows the user to auto switch to the webpage having the maximum number of key points/information amongst a plurality of related webpages. FIG. 16C illustrates a sample user interface 1605 provided to the user for selection of the functionality. Option 1606 allows the user to highlight website having the maximum number of key points/information. Option 1607 allows the user to auto switch to the webpage having the maximum number of key points/information. This functionality provided by the present disclosure may be advantageous to the user. Automatic identification of the website having the maximum number of unique key points is provided to the user so that the user need not browse each and every website.

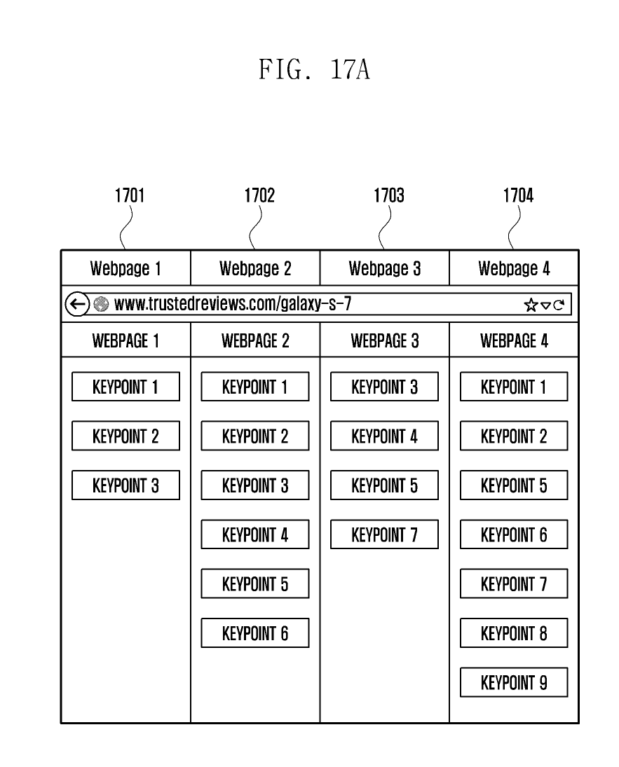

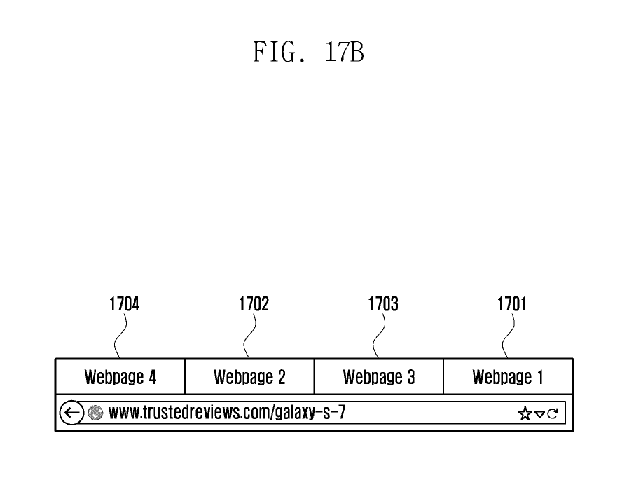

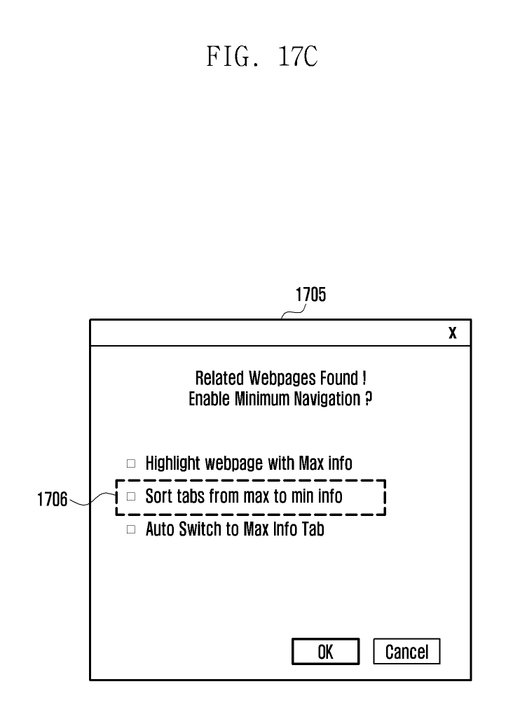

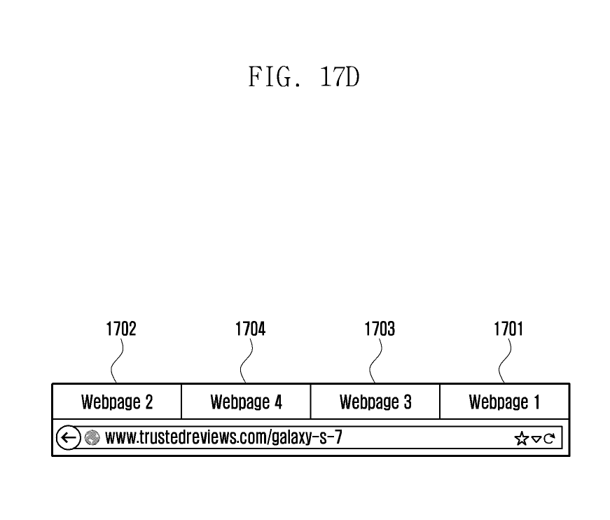

FIGS. 17A to 17D illustrate functionalities provided to the user, in accordance with an example embodiment.

FIGS. 17A to 17D illustrate the functionality wherein a plurality of related webpages are sorted in a descending order, a first related webpage in the order having a maximum number of the unique key points and a last related webpage in the order having a minimum number of unique key points. FIG. 17A illustrates webpages 1701, 1702, 1703 and 1704 and key points related to each webpage. As can be seen, webpage 1701 includes 3 key points, webpage 1702 includes 6 key points, webpage 1703 includes 4 key points and webpage 1704 includes 7 key points. Accordingly, the webpages will be sorted in a descending order as illustrated by FIG. 17B wherein webpage 1704 is displayed first and the webpage 1701 is displayed last. It is to be understood that the same can be arranged in an ascending order. FIG. 17C illustrates a sample user interface 1705 provided to the user for selection of the functionality. Option 1706 allows the user to sort webpages/tabs in a descending order. A plurality of related webpages, apart from a current webpage, may be sorted in a predetermined order. For example, if the user is currently on webpage 1702, the rest of the webpages may be sorted in a predetermined order. FIG. 17D illustrates such a case, wherein when the user is on webpage 1702, the rest of the webpages (i.e. webpages 1701, 1703 and 1704) are sorted in a descending order wherein webpage 1704 having the maximum number of key points is listed first and webpage 1701 having the minimum number of remaining key points is listed last. It is to be noted that the webpage 1703 has duplicative key points and may also be automatically closed.

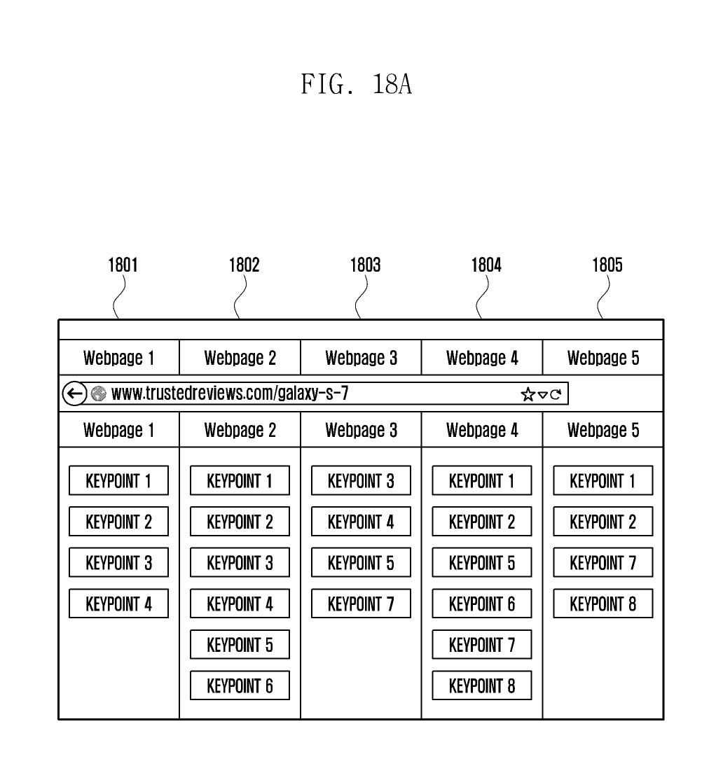

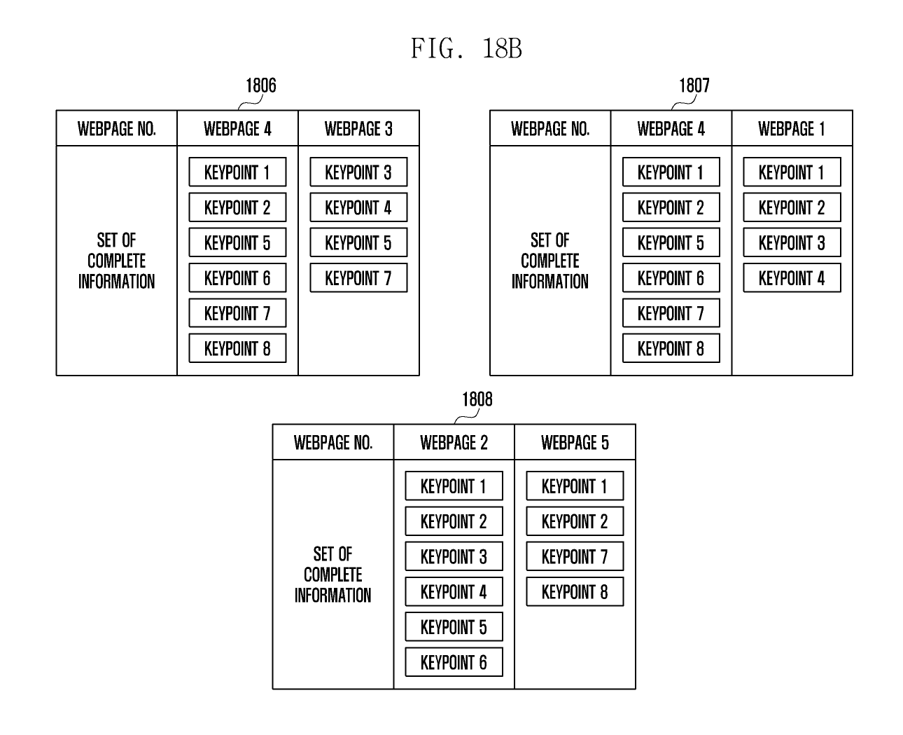

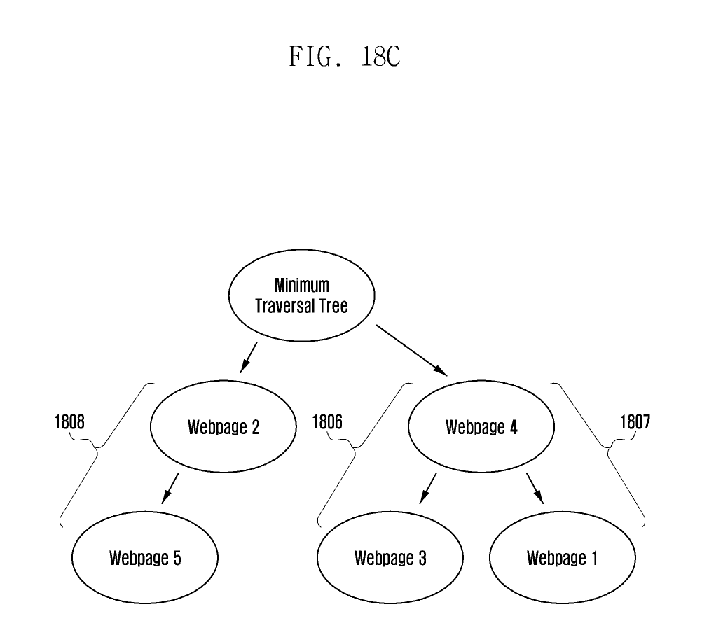

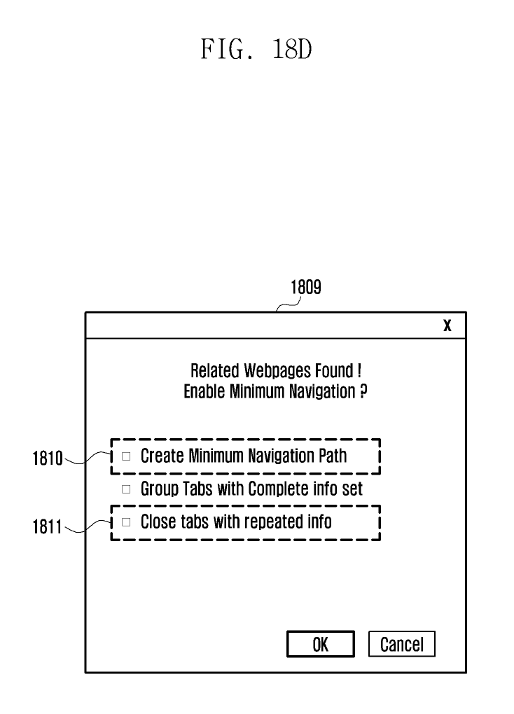

FIGS. 18A to 18D illustrate functionalities provided to the user, in accordance with an example embodiment.

FIGS. 18A to 18D illustrate the functionality wherein the present disclosure indicates one or more minimum navigational paths, said minimum navigational path displaying a related webpage having the maximum number of unique key points from the list of unique key points and at least one related webpage having a remaining number of unique key points. FIG. 18A illustrates webpages 1801, 1802, 1803, 1804 and 1805 and key points associated with each webpage. As can be seen, webpage 1802 and webpage 1804 have the maximum number of unique key points. The present disclosure prepares sets of minimum websites having all the key points and accordingly prepares a data structure with the minimum traversal. FIG. 18B illustrates the sets 1806, 1807 and 1808 of minimum websites which contain complete information in a tabular form. FIG. 18C illustrates the sets 1806, 1807 and 1808 of minimum websites which contain the complete information in a data structure with a minimum traversal tree. As seen, set 1806 is a combination of webpage 1803 and webpage 1804, set 1807 is a combination of webpage 1801 and 1804 and set 1808 is a combination of webpage 1802 and 1805 which contain complete information. It is noted that in such an embodiment the user may be provided with functionality to close the webpages that are not included in the sets (i.e. including key points which are already covered in the sets). FIG. 18D illustrates a sample user interface 1809 provided to the user for selection of said functionality. Option 1810 allows the user to create a minimum navigation path. Option 1811 allows the user to close the following: webpages with key points already covered in other webpages, webpages including duplicative information or webpages not indicated in the minimum navigational path. Webpages with the following: key points already covered in other webpages, duplicative information or not indicated in the minimum navigational path may be automatically closed. When a minimum navigational path indicates more than two webpages, the present disclosure may automatically navigate from a webpage having maximum number of key points to related webpages having remaining number of key points. The auto-navigation may occur in a predetermined order, such as an ascending order or a descending order.

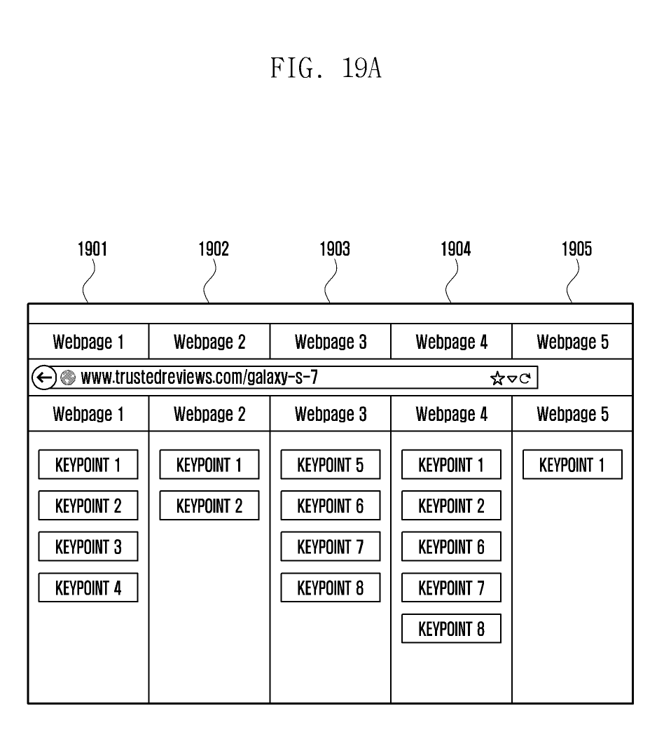

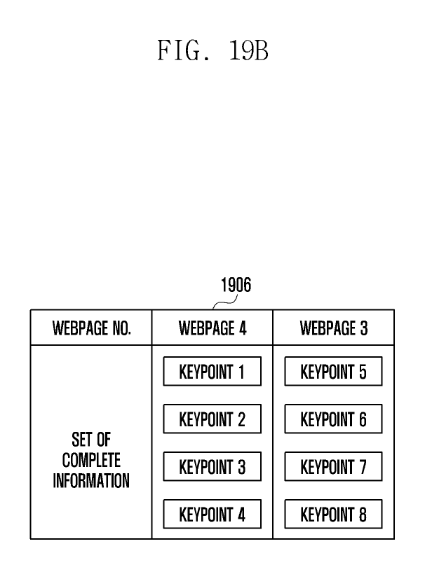

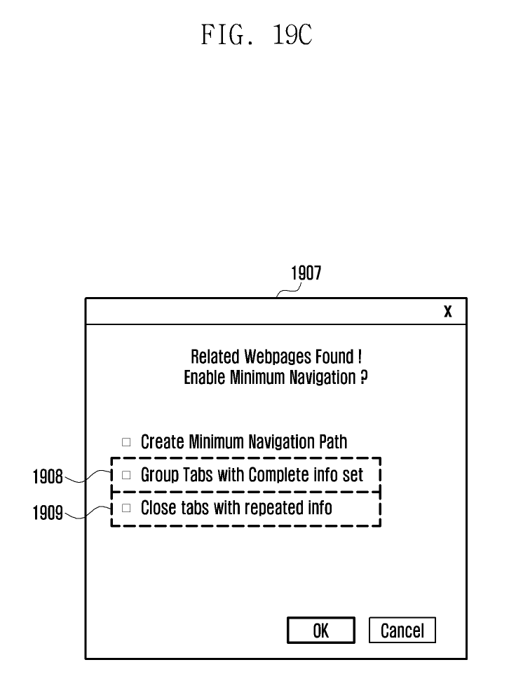

FIGS. 19A to 19C illustrate functionalities provided to the user, in accordance with an example embodiment.

FIGS. 19A to 19C illustrate the functionality wherein at least one set of related webpages from amongst the plurality of related webpages is grouped, the at least one set of webpages including all the unique key points. It is to be understood that more than one set may exist, wherein each set includes webpages having all the unique key points. If more than one set exist, the sets can be visually distinguished. The options for visually distinguishing include one or more of: font changes, effects, color change and the like. FIG. 19A illustrates webpages 1901, 1902, 1903, 1904 and 1905 and key points related to each webpage. FIG. 19B illustrates a first set 1906 of related webpages having all the unique key points. As shown, the first set 1906 includes webpage 1901 and webpage 1903. It is to be noted that in said functionality (i) the first set is a non-null set and includes at least two related webpages, (ii) the first set do not necessarily include the webpage having maximum number of key points, and (iii) the user may be provided with functionality to close the webpages that are not included in the first set. FIG. 19C illustrates a sample user interface 1907 provided to the user for selection of the functionality. Option 1908 allows the user to create sets having all the unique key points. Option 1909 allows the user to close webpages with key points already covered in the set 1906. When the at least one set of related webpages includes more than two related webpages, the related webpages may be sorted in a predetermined order, such as an ascending order or a descending order. Also, in a given set, the present disclosure auto-navigates from a webpage having maximum number of key points to one or more related webpages having remaining number of key points. The auto-navigation occurs in a predetermined order, the predetermined order including an ascending order or a descending order.

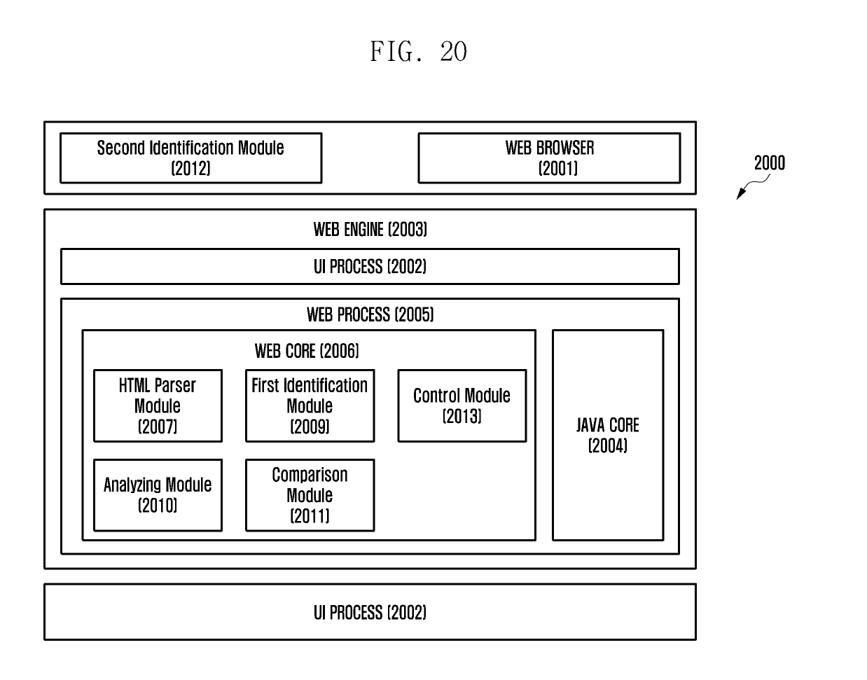

FIG. 20 illustrates constructional details of a device 2000, in accordance with an example embodiment.

A web browser 2001 is a software application for retrieving, presenting, and exchanging information resources on the World Wide Web (WWW). The web browser includes a user interface (UI) process 2002, a web browser engine 2003, Java core 2004 (also known as Javascript interpreter), web process 2005 and a web core 2006. The web core 2006 is a layout, rendering, and document object model (DOM) library for Hypertext Markup Language (HTML). The web core 2006 may include an HTML parser module 2007. An HTML document may contain text and/or refer to images. The nodes of every HTML document are organized in a tree structure called the DOM tree which is generated by the HTML parser module.

Further, the web browser engine 2003, also known as a layout engine, is a software component that takes up marked up content such as HTML, extensible Markup language (XML), and image file and formatting information such as cascading style sheets (CSS), extensible style sheet (XSL) and displays the formatted content on the screen. A platform for the web browser can be one of HTML, CSS, DOM and Javascript. Examples of web browsers include but are not limited to Internet explorer, Mozilla, Firefox, Safari, Google chrome, Konqueror, Arora, Dillo, Lynx, Amaya, Netpositive, Planetweb and Netscape.

The device 2000 of the present disclosure, apart from the above-mentioned which is already known in the art, may include a first identification module 2009, an analyzing module 2010, a comparison module 2011, a second identification module 2012 and a control module 2013.

The first identification module 2009 is configured for identifying, based on a predetermined criterion, a plurality of related webpages from a plurality of webpages opened in at least one tab. The first identification module 2009 is in communication with the HTML parser module 2007. The predetermined criterion includes presence of at least one matching/similar text in one or more of: uniform resource locator of the related webpage; title of the related webpage, the title extracted from a DOM tree structure created for each webpage; heading of the related webpages, the heading extracted from the DOM tree structure created for each webpage; and meta data within the related webpage.

The analyzing module 2010 is configured for analyzing content of each related webpage and extracting one or more key points corresponding to each related webpage. The analyzing module 2010 extracts one or more key points using one or more of: (a) natural language processing (NLP), (b) web scraping, (c) DOM parsing, (d) summarization and (e) semantic analysis. The analyzing module is in communication with the HTML Parser Module and the first identification module.

The comparison module 2011 is configured for comparing the key points present in the related webpages. The comparison module 2011 compares one or more key points using one or more of: point-to-point comparison, textual paragraph/summary comparison, and multimedia comparison.

The second identification module 2012 is configured for identifying a user input pattern indicative of performing an action on at least one of the plurality of related webpages. The control module 2012 is configured for providing, based on user input identified by second identification module, at least one functionality to the user with respect to the plurality of related webpages. One of the user input pattern identified by the second identification module 2012 is closing of one or more related webpages. The functionality provided by the control module 2013 on closing one or more related webpages is: (a) closing all the related webpages, (b) saving all the related webpages, (c) printing all the related webpages, (d) emailing all the related webpages, (e) copying all the related webpages, (f) saving highlighted key points in the related webpages, (g) printing highlighted key points in the related webpages, (h) emailing highlighted key points in the related webpages, (i) copying highlighted key points in the related webpages, (j) saving the related webpages having highlighted key points, (k) printing the related webpages having highlighted key points, (l) copying the related webpages having highlighted key points, (m) emailing the related webpages having highlighted key points, (n) saving the related webpages having maximum number of key points, (o) printing the related webpages having maximum number of key points, (p) copying the related webpages having maximum number of key points, (q) emailing the related webpages having maximum number of key points, (r) saving a first set of related webpages having all the key points, (s) emailing a first set of related webpages having all the key points; (t) copying a first set of related webpages having all the key points, and (u) printing a first set of related webpages having all the key points.

Another user input pattern identified by the second identification module 2000 may be one of: switching between related webpages, opening one or more related webpages, navigating within a related webpage, and switching web browser windows. The functionality provided by the control module 2013 on receiving one of the user input pattern may be: (a) highlighting one or more key points on a current related webpage, the one or more key points absent in one or more previously accessed and related webpages, (b) auto-scrolling to one or more key points on a current related webpage, the one or more key points absent in one or more previously accessed and related webpages, (c) highlighting one or more key points on a current related webpage, the one or more key points present in one or more previously accessed and related webpages, (d) auto-scrolling to one or more key points on a current related webpage, the one or more key points present in one or more previously accessed and related webpages, (e) highlighting one or more key points on a current related webpage, the one or more key points browsed in one or more previously accessed and related webpages, (f) auto-scrolling to one or more key points on a current related webpage, the one or more key points browsed in one or more previously accessed and related webpages, (g) highlighting one or more key points on a current related webpage, the one or more key points un-browsed in one or more previously accessed and related webpages, (h) auto-scrolling to one or more key points on a current related webpage, the one or more key points un-browsed in one or more previously accessed and related webpages, and (i) creating a virtual page corresponding to a current webpage, the virtual page displaying one or more key points absent in one or more previously accessed and related webpages.

The device 2000 may further include a dynamic update module, the module configured for dynamically updating the at least one functionality discussed above based on one or more of: interaction with a currently opened webpage; and detection of a new related webpage.

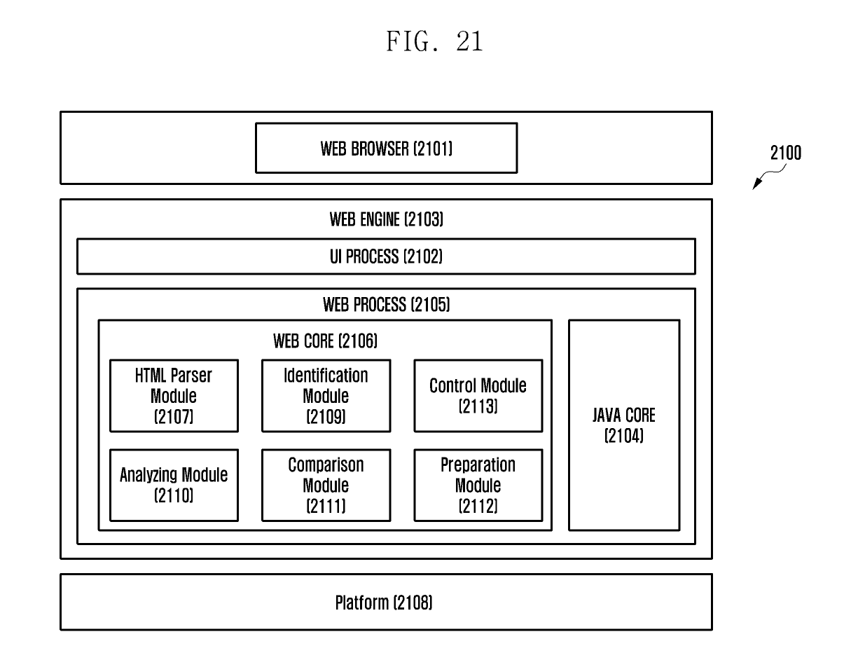

FIG. 21 illustrates constructional details of a device 2100, in accordance with an embodiment of the present disclosure.

A web browser 2101 is a software application for retrieving, presenting, and traversing information resources on the World Wide Web (WWW). The web browser includes a user interface (UI) process 2102, a web browser engine 2103, Java core 2104 (also known as Java script interpreter), web process 2105 and a web core 2106. The web core 2106 is a layout, rendering, and document object model (DOM) library for Hypertext Mark-up Language (HTML). The web core 2106 may include a HTML parser module 2107. As already known, an HTML document may contain text and/or refer to images. The nodes of every HTML document are organized in a tree structure called the DOM tree which is generated by the HTML parser module 2107.

Further, the web browser engine 2103. also known as a layout engine, is a software component that takes up marked up content such as HTML, extensible Mark-up language (XML), and image file and formatting information such as cascading style sheets (CSS), extensible style sheet (XSL) and displays the formatted content on the screen. A platform 2108 for the web browser may be one of HTML, CSS, DOM and Javascript. Examples of web browsers include but are not limited to Internet explorer, Mozilla, Firefox, Safari, Google chrome, Konqueror, Arora, Dillo, Lynx, Amaya, Netpositive, Planetweb and Netscape.

The device 2100 of the present disclosure, apart from the above-mentioned which is already known in the art, may include an identification module 2109, an analyzing module 2110, a comparison module 2111, a preparation module 2112 and a control module 2113.

The identification module 2109 is configured for identifying, based on a predetermined criterion, a plurality of related webpages from a plurality of webpages opened in at least one tab. The identification module 2109 is in communication with the HTML parser module 2107. The predetermined criterion includes presence of at least one matching/similar text in one or more of: (a) uniform resource locator of the related webpage, (b) title of the related webpage, the title extracted from a DOM tree structure created for each webpage, (c) heading of the related webpages, the heading extracted from the DOM tree structure created for each webpage, and (d) meta data within the related webpage.

The analyzing module 2110 is configured for analyzing content of each related webpage and extracting one or more key points corresponding to each related webpage. The analyzing module 2110 extracts one or more key points using one or more of: (a) natural language processing (NLP), (b) web scraping, (c) DOM parsing, (d) summarization and (e) semantic analysis. The analyzing module 2110 is in communication with the HTML parser module 2107 and the identification module 2109.

The comparison module 2111 is configured for comparing the key points present in the related web-pages. The comparison module compares one or more key points using one or more of: point-to-point comparison, textual paragraph/summary comparison, and multimedia comparison.

The preparation module 2112 is configured for preparing a list of unique key points present in all the related webpages and the control module 2113 is configured for providing at least one functionality to a user with respect to the plurality of related webpages, the functionality includes one or more of: (a) highlighting one or more related webpages having a maximum number of the unique key points from the list of unique key points, (b) sorting related webpages in a descending order, a first related webpage in the order having a maximum number of the unique key points and a last related webpage in the order having a minimum number of unique key points, (c) automatically switching to a webpage having a maximum number of the unique key points from the list of unique key points, (d) indicating one or more minimum navigational paths, the minimum navigational path displaying a related webpage having maximum number of unique key points from the list of unique key points and at least one related webpage having a remaining number of unique key points, and (e) grouping a first set of related webpages from amongst the plurality of related webpages such that the first set of webpages includes all the unique key points.

The device 2100 may further include a dynamic update module, the module configured for dynamically updating the at least one functionality discussed above based on one or more of: interaction with a currently opened webpage, and detection of a new related webpage.

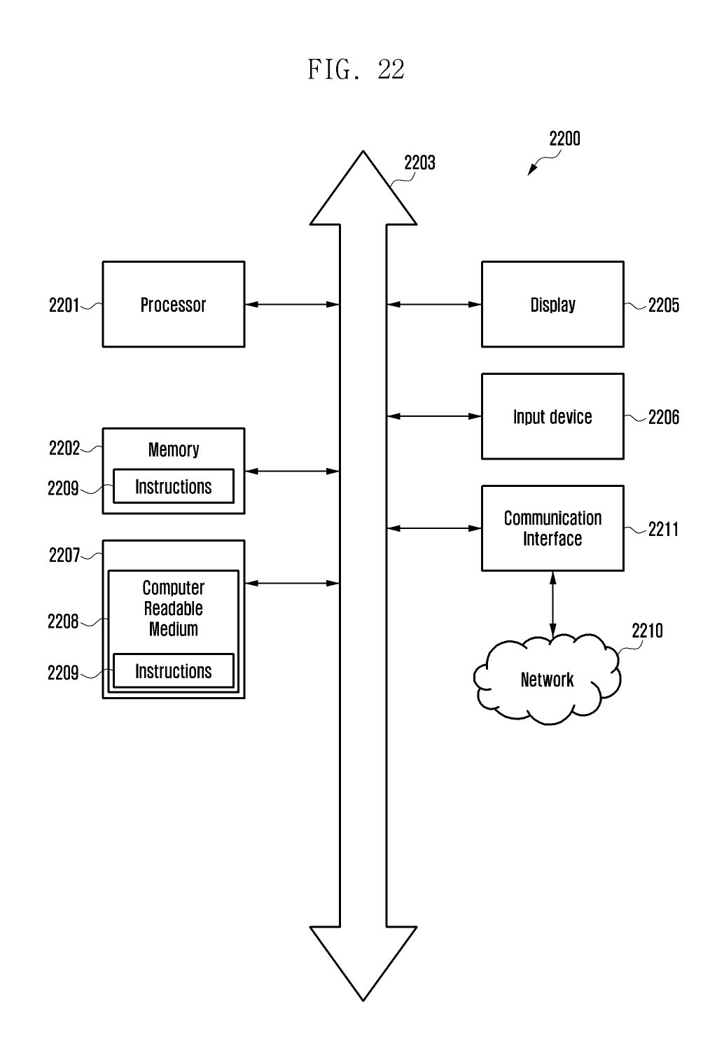

FIG. 22 illustrates a typical hardware configuration of the device 2000 and 2100 in the form of a computer system 2200, in accordance with an example embodiment. The computer system 2200 may include a set of instructions that can be executed to cause the computer system 2200 to perform any one or more of the methods disclosed. The instructions may be stored in a computer-readable medium. The computer system 2200 may operate as a standalone device or may be connected, e.g., using a network, to other computer systems or peripheral devices.

In a networked deployment, the computer system 2200 may operate in the capacity of a server or as a client computer in a server-client user network environment, or as a peer computer system in a peer-to-peer (or distributed) network environment. The computer system 2200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a wearable computing device, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system 2200 is illustrated, the term “device” shall also be taken to include any collection of systems or sub-systems that individually or jointly execute a set, or multiple sets, of instructions to perform one or more computer functions.

The computer system 2200 may include a processor 2201, e.g., a central processing unit (CPU), a graphics processing unit (GPU), or both. The processor 2201 may be a component in a variety of systems. For example, the processor 2201 may be part of a standard personal computer or a workstation. The processor 2201 may be one or more general processors, digital signal processors, application specific integrated circuits, field programmable gate arrays, servers, networks, digital circuits, analog circuits, combinations thereof, or other now known or later developed devices for analyzing and processing data The processor 2201 may implement a software program, such as code generated manually (i.e., programmed).

The computer system 2200 may include a memory 2202, such as a memory 2202 that can communicate via a bus 2203. The memory 2202 may be a main memory, a static memory, or a dynamic memory. The memory 2202 may include, but is not limited to computer readable storage media such as various types of volatile and non-volatile storage media, including but not limited to random access memory (RAM), read-only memory (ROM), programmable read-only memory (PROM), electrically programmable read-only memory (EPROM), electrically erasable read-only memory (EEPROM), flash memory, magnetic tape or disk, optical media and the like. In one example, the memory 2202 includes a cache or random access memory for the processor 2201. In alternative examples, the memory 2202 is separate from the processor 2201, such as a cache memory of a processor, the system memory, or other memory. The memory 2202 may be an external storage device or database for storing data. Examples include a hard drive, a compact disc (CD), a digital video disc (DVD), a memory card, a memory stick, a floppy disc, a universal serial bus (USB) memory device, or any other device operative to store data. The memory 2202 is operable to store instructions executable by the processor 2201. The functions, acts or tasks illustrated in the figures or described may be performed by the programmed processor 2201 executing the instructions stored in the memory 2202. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 2200 may further include a display 2205, such as a liquid crystal display (LCD), an organic light emitting diode (OLED), a flat panel display, a solid state display, a cathode ray tube (CRT), a projector, a printer or other now known or later developed display device for outputting determined information. The display 2205 may act as an interface for the user to see the functioning of the processor 2201, or specifically as an interface with the software stored in the memory 2202 or in a drive unit 2207.

The computer system 2200 may also include a disk or optical drive unit 2207. The disk drive unit 2207 may include a computer-readable medium 2208 in which one or more sets of instructions 2209, e.g. software, can be embedded. Further, the instructions 2209 may embody one or more of the methods or logic as described. In a particular example, the instructions 2209 may reside completely, or at least partially, within the memory 2202 or within the processor 2201 during execution by the computer system 2200. The processor 2201 and the memory 2202 may also include computer-readable media as discussed above.

One or more example embodiments may be implemented by a computer-readable medium that includes instructions 2209 or receives and executes instructions 2209 responsive to a propagated signal so that a device connected to a network 2210 can communicate voice, video, audio, images or any other data over the network 2210. Further, the instructions 2209 may be transmitted or received over the network 2210 via a communication port or interface 2211 or using the bus 2203. The communication port or interface 2211 may be a part of the processor 2201 or may be a separate component. The communication interface 2211 may be created in software or may be a physical connection in hardware. The communication interface 2211 may be configured to connect with a network 2210, external media, the display 2205, or any other components in system 2200, or combinations thereof. The communication interface 2211 may include transmitter for transmitting data and/or receiver for receiving data. The connection with the network 2210 may be a physical connection, such as a wired Ethernet connection or may be established wirelessly as discussed later. Likewise, the additional connections with other components of the system 2200 may be physical connections or may be established wirelessly. The network 2210 may alternatively be directly connected to the bus 2203.

The network 2210 may include wired networks, wireless networks, Ethernet Audio Video Bridging (AVB) networks, or combinations thereof. The wireless network may be a cellular telephone network, an 802.11, 802.16, 802.20, 802.1Q or WiMax network. Further, the network 2210 may be a public network, such as the Internet, a private network, such as an intranet, or combinations thereof, and may utilize a variety of networking protocols now available or later developed including, but not limited to Transmission Control Protocol/Internet Protocol (TCP/IP)-based networking protocols.

Additionally, the computer system 2200 may include an input device 2206 configured to allow a user to interact with any of the components of system 2200. The input device 2206 may be a number pad, a keyboard, or a cursor control device, such as a mouse, or a joystick, touch screen display, remote control or any other device operative to interact with the computer system 2200.

In an alternative example, dedicated hardware implementations, such as application specific integrated circuits, programmable logic arrays and other hardware devices, can be constructed to implement various parts of the system 2200. Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, User Datagram Protocol/Internet Protocol (UDP/IP), HTML, Hypertext Transfer Protocol (HTTP)) may be used. Such standards are periodically superseded by faster or more efficient equivalents having essentially the same functions. Accordingly, replacement standards and protocols having the same or similar functions as those disclosed are considered equivalents thereof. It may be noted that the method as described in the present disclosure can be implemented in a wide variety of electronic devices including but not limited to desktop computers, lap top computers, palm top computers, tabs, mobile phones, televisions, etc. Also, the user input can be received by the system using a wide variety of techniques including but not limited to using a mouse, a gesture input, a touch input, a stylus input, a joy stick input, a pointer input, etc.

While certain present preferred embodiments of the disclosure have been illustrated and described herein, it is to be understood that the disclosure is not limited thereto. Clearly, the disclosure may be otherwise variously embodied, and practiced within the scope of the following claims.

We claim:

1. A method for providing at least one functionality using an electronic device, the method comprising:
extracting at least one key point from each of a plurality of webpages corresponding to each of a plurality of tabs that are open on a web browser;
comparing the at least one key point corresponding to the each of the plurality of webpages with each other; and
providing, based on a result of the comparing the at least one key point, at least one functionality with respect to at least one of the plurality of webpages.

2. The method of claim 1, further comprising identifying, based on a predetermined criterion, whether the plurality of webpages are related to each other,
wherein the predetermined criterion comprises presence of at least one related text in at least one of:
uniform resource locators (URLs) of the plurality of webpages;
titles of the plurality of webpages, the titles being extracted from a document object model (DOM) tree structure created for the each of the plurality of webpages; and
metadata within the plurality of webpages.

3. The method of claim 1, wherein the at least one key point is extracted using at least one of natural language processing (NLP), web scraping, DOM parsing, summarization, and semantic analysis.

4. The method of claim 1, further comprising:
displaying a plurality of indicators on a screen of the web browser, each of the plurality of indicators corresponding to the each of the plurality of tabs; and
receiving a user input for at least one of the plurality of indicators.

5. The method of claim 4, wherein the user input is for removing one of the plurality of indicators, and
wherein the at least one functionality comprises at least one of removing all the plurality of indicators, storing data associated with all the plurality of webpages in the electronic device, and transmitting the data associated with all the plurality of webpages to an external electronic device.

6. The method as claimed in claim 4, wherein the user input is for displaying one of the plurality of webpages on the screen by selecting one of the plurality of indicators, and
wherein the providing the at least one functionality comprises highlighting at least one key point included in the one of the plurality of webpages displayed on the screen based on the result of the comparing.

7. The method of claim 4, further comprising generating a list of the at least one key point extracted from all the plurality of webpages.

8. The method of claim 7, wherein the providing the at least one functionality comprises highlighting one of the plurality of indicators, and
wherein the highlighted indicator corresponds to a webpage having a largest number of key points included in the list among the plurality of webpages.

9. The method of claim 7, wherein the providing the at least one functionality comprises sorting the plurality of indicators according to a number of key points included in the each of the plurality of webpages.

10. The method of claim 7, wherein the providing the at least one functionality comprises grouping at least one set of related webpages from among the plurality of webpages such that the at least one set of related webpages comprises all the key points included in the list.

11. A device comprising:
a display; and
a processor electrically connected to the display,
wherein the processor is configured to:
extract at least one key point from each of a plurality of webpages corresponding to each of a plurality of tabs that are open on a web browser;
compare the at least one key point corresponding to the each of the plurality of webpages with each other; and
provide, based on a result of the comparing the at least one key point, at least one functionality to a user with respect to at least one of the plurality of webpages.

12. The device of claim 11, wherein the processor is configured to identify, based on a predetermined criterion, whether the plurality of webpages are related to each other,
wherein the predetermined criterion comprises presence of at least one related text in at least one of:
uniform resource locators (URLs) of the plurality of webpages;
titles of the plurality of webpages, the titles being extracted from a document object model (DOM) tree structure created for the each of the plurality of webpages; and
metadata within the plurality of webpages.

13. The device of claim 11, wherein the at least one key point is extracted using at least one of natural language processing (NLP), web scraping, DOM parsing, summarization, and semantic analysis.

14. The device of claim 11, further comprising an input device,
wherein the processor is further configured to:
control the display to display a plurality of indicators on a screen of the web browser, each of the plurality of indicators corresponding to the each of the plurality of tabs; and
receive, through the input device, a user input for at least one of the plurality of indicators.

15. The device of claim 14, wherein the user input is for removing one of the plurality of indicators, and
wherein the at least one functionality provided by the processor comprises at least one of: removing all the plurality of indicators, storing, in a memory of the electronic device, data associated with all the plurality of webpages in the device, and transmitting, through a transmitter of the device, the data associated with all the plurality of webpages to an external electronic device.

16. The device of claim 14, wherein the user input is for displaying one of the plurality of webpages on the screen by selecting one of the plurality of indicators, and
wherein the processor is further configured to control the display to highlight at least one key point included in the one of the plurality of webpages displayed on the screen based on the result of the comparing.

17. The device of claim 14, wherein the processor is configured to generate a list of the at least one key point extracted from all the plurality of webpages.

18. The device of claim 17, wherein the processor is further configured to control the display to highlight one of the plurality of indicators, and
wherein the highlighted indicator corresponds to a webpage having a largest number of key points included in the list among the plurality of webpages.

19. The device of claim 17, wherein the processor is further configured to sort the plurality of indicators according to a number of key points included in the each of the plurality of webpages.

20. The device of claim 17, wherein the processor is further configured to group at least one set of related webpages from among the plurality of webpages such that the at least one set of related webpages comprises all the key points included in the list.
